(19) United States
(12) Patent Application Publication
(10) Pub. No.: US 2019/0291538 A1
(43) Pub. Date: Sep. 26, 2019

(54) INTERIOR ENVIRONMENT ADJUSTING DEVICE, VEHICLE WITH THE SAME, AND INTERIOR ENVIRONMENT ADJUSTING METHOD

(71) Applicant: HONDA MOTOR CO., LTD., Tokyo (JP)

(72) Inventors: Daisuke Miura, Tochigi (JP); Yoko Nishi, Tokyo (JP)

(21) Appl. No.: 16/360,294

(22) Filed: Mar. 21, 2019

(30) Foreign Application Priority Data
Mar. 26, 2018 (JP) 2018-058361
Mar. 26, 2018 (JP) 2018-058363
Mar. 26, 2018 (JP) 2018-058364

(51) Int. Cl. B60H 1/00

(52) U.S. Cl. CPC B60H 1/00792; B60H 2001/3248; B60H 1/00899; B60H 1/00585

(57) ABSTRACT

The control part ECU of the interior environment adjusting device 1 for adjusting the environment inside the compartment C of the vehicle V1 executes adjustment to make inside air pressure that is air pressure inside the compartment C into positive pressure to outside air pressure that is air pressure around the vehicle V1 using oxygen-enriched air generated by the oxygen enrichment mechanism 21, and adjustment to make an oxygen concentration inside the compartment C to be a higher concentration than in the outside air.

### BACKGROUND OF THE INVENTION

### Field of the Invention

The present invention relates to an interior environment adjusting device for adjusting an inside environment of a mobile body, a vehicle with the device, and an interior environment adjusting method.

### Description of the Related Art

Conventionally, there is a device for restraining an influence that an inside environment gives to a physical condition of a passenger by adjusting the inside environment in which a passenger is present while driving a vehicle. A device for reducing an uncomfortable feeling due to variation of an air pressure by detecting a variation of the inside air pressure and adjusting the inside airtightness to restrain the variation is known as such a kind of device (for example, see Patent Document 1).

Also, a device for keeping inside air pressure within a predetermined range to restrain deterioration of a physical condition of a passenger due to variation of the air pressure by adjusting an amount of outside air introduced to an inside from outside of a vehicle is known as such a kind of device (for example, see Patent Document 2).

### PRIOR ART DOCUMENTS

### Patent Documents

### Patent Document 1: Japanese Patent Application Laid-Open No. 2004-276883

Patent Document 2: Japanese Patent Application Laid-Open No. H09-226355

However, the devices described in Patent Documents 1 and 2 can merely prevent deterioration of a physical condition of a passenger by restraining the influence due to the variation of the air pressure accompanied by the movement of the vehicle. Therefore, a new additional value to positively maintain or improve the physical condition of the passenger using this device while the vehicle is not necessarily moving cannot be given to the vehicle.

Also, the device described in Patent Document 1 adjusts the inside environment with a condition around the vehicle (e.g., air pressure) as a reference, example, when the air pressure around the vehicle is extremely unstable, the inside air pressure significantly varies accordingly. As a result, there is a risk that the passenger might feel a fatigue feeling by the adjustment of the inside environment executed to reduce a burden onto the passenger, and the physical condition of the passenger cannot be maintained.

The present invention is made in light of the above-mentioned problems, and an object of the present invention is to provide an interior environment adjusting device that can maintain and improve the physical condition of the passenger, a vehicle with the device, and an interior environment adjusting method.

### SUMMARY OF THE INVENTION

An interior environment adjusting device according to the present invention is an interior environment adjusting device for adjusting an inside environment of a mobile body, and includes an environment adjusting part for executing at least one of adjustment to make inside air pressure that is air pressure in the inside into positive pressure with respect to outside air pressure that is air pressure around the mobile body, and adjustment to make an oxygen concentration in the inside to a higher concentration than in the outside air.

Generally, when oxygen is sufficiently taken into a body, it is known that such an effect for maintaining and improving a physical condition can be obtained. Here, “maintenance and improvement of a physical condition” includes restraint of fatigue due to driving, recovery, restraint of drowsiness, recovery from injuries, a diet effect, dissolution of lactic acids, improvement of memory abilities, improvement of a skin condition, and the like.

When oxygen is taken into a body through a respiration organ, the amount of the taken oxygen (bound oxygen amount) depends on an amount of hemoglobin in blood bound with oxygen. Therefore, there is a risk that oxygen cannot be sufficiently taken into the body even when an oxygen supply amount is increased, according to the amount of hemoglobin. In this case, it is difficult that oxygen reaches a terminal end of a capillary vessel thinner than hemoglobin, and a sufficient effect cannot be obtained even when the amount of bound oxygen is increased.

As a result of earnest research, the present inventors have obtained a finding that the amount of dissolved oxygen directly taken in blood of a subject can be increased by making air pressure of gas existing around the subject into positive pressure to atmospheric air pressure or increasing an oxygen concentration of the gas, or satisfying both of them. Also, the inventors have obtained a finding that the oxygen concentration in atmospheric air is particularly preferably 20% or more and 40% or less and the air pressure is particularly preferably 1.1 atm or more and 2 atm or less, to increase the dissolved oxygen amount in a human body.

In the interior environment adjusting device according to the present invention, at least one of adjustment to make inside air pressure that is inside air pressure into the positive pressure with respect to outside air pressure(i.e., atmospheric air pressure) that is air pressure around the mobile body, and adjustment to make an oxygen concentration in the inside a higher concentration than in the outside air, is executed to the inside environment (a gas condition).

The mobile body with the interior environment adjusting device can realize such environment that oxygen can be easily and effectively taken into a body in an inside, so that a physical condition can be maintained and improved by increasing the dissolved oxygen amount of the passenger in the inside. As a result, a new additional value other than merely moving means can be given to the mobile body as physical condition maintaining and improving means.

In the interior environment adjusting device according to the present invention, it is preferable that the environment adjusting part executes an adjustment to make the inside air pressure into the positive pressure with respect to the outside air pressure and also make differential pressure between the outside air pressure and the inside air pressure constant.

When the differential pressure between the inside air pressure and the outside air pressure around the mobile body varies, a force for deforming a vehicle body is applied to the vehicle body according to its variation. When the differential pressure is large, a degree of deformation of the vehicle body becomes large, vibration and noise are generated inside and an uncomfortable feeling might be given to the passenger.

Therefore, when the device is configured so that the differential pressure between the inside air pressure and the outside air pressure is constant, such a force applied to the vehicle body is restrained, and vibration and noise due to the deformation are also restrained. Thus, giving an uncomfortable feeling to the passenger can be inhibited.

The interior environment adjusting device according to the present invention comprises a passenger recognition part for recognizing presence of a passenger in an inside. It is preferable that the environment adjusting part executes the adjustment when the passenger is present in the inside.

By such a configuration, a difference between inside environment with no passenger and environment outside the mobile body is prevented. Therefore, a phenomenon due to the variation of the environment (for example, noise in ears during boarding, and variation of a force required for an opening and closing operation of a door) is restrained. Thus, giving an uncomfortable feeling to the passenger during boarding can be inhibited.

Even when an auto-start function and the like for adjusting inside environment by starting an air-conditioner and the like before boarding is adopted, excessive adjustment of the inside environment is prevented, so that waste consumption of energy for adjusting the inside environment can be prevented.

Also, when the interior environment adjusting device according to the present invention is configured to recognize the presence of the passenger in the inside, it is preferable that the passenger recognition part recognizes the number of passengers, and the environment adjusting part executes the adjustment to make an oxygen concentration in the inside a higher concentration than in the outside air by adjusting the inside oxygen supply amount based on the recognized number of the passengers.

A degree of the variation of the inside environment (in particular, oxygen concentration) is significantly influenced by the number of the passengers in the inside (i.e., an amount of oxygen consumed by respiration of the passengers). To adjust the inside environment, the amount of the consumed oxygen must be considered. Therefore, when the inside environment is adjusted by determining the inside oxygen supply amount based on the number of the passengers (i.e., by predicting the amount of the consumed oxygen and calculating the oxygen supply amount for supplementing the consumption amount), the condition of gas can be easily made into a desired condition.

Also, the interior environment adjusting device according to the present invention includes a physical condition recognition part for recognizing a physical condition of a passenger. It is preferable that the environment adjusting part executes the adjustment when the recognized physical condition of the passenger is a predetermined physical condition.

Here, “a predetermined physical condition” indicates a physical condition determined that there is a need of improving and enhancing a physical condition. For example, it indicates such a physical condition that a degree of fatigue or a degree of drowsiness of the recognized passenger exceeds a threshold. A reference for determining whether or not it is a predetermined physical condition may be set appropriately. Also, “a physical condition recognition part” may automatically recognize the physical condition of the passenger, and may appropriately allow the passenger herself to input and set the physical condition.

By such a configuration, oxygen can be efficiently supplied to the passenger while limited to a timing at which there is a need of maintaining and improving the physical condition. As a result, the excessive adjustment of the inside environment is prevented, so that waste consumption of energy for adjusting the inside environment can be prevented.

When the interior environment adjusting device according to the present invention is configured to recognize the physical condition of the passenger, the physical condition recognition part preferably recognizes the physical condition of the passenger based on biological information of the passenger transmitted from a mobile information terminal.

By such a configuration, not only a condition that the passenger boards the mobile body, but also the biological information before the passenger boards the mobile body can be referred, so that the physical condition of the passenger can be recognized more properly. Thereby, a gas condition proper to the passenger can be set, so as to further maintain and improve the physical condition.

Here, “a mobile information terminal” may include a mobile phone, a wearable terminal, a laptop computer, and any device that can acquire information relating to the physical condition of the passenger outside the mobile body, and that has a communication function capable of transmitting the information relating to the physical condition of the passenger to the interior environment adjusting device.

Also, in the interior environment adjusting device according to the present invention, the environment adjusting part preferably executes the adjustment step by step so that the inside air pressure becomes positive pressure with respect to the outside air pressure.

When the inside air pressure is rapidly increased, there is a risk that an uncomfortable feeling might be given to the passenger. Thus, by varying the inside air pressure step by step, giving such an uncomfortable feeling can be inhibited.

The interior environment adjusting device according to the present invention includes an exhaust amount adjusting mechanism for adjusting an exhaust amount of air from the inside, and a traveling condition recognition part for recognizing a traveling condition of the mobile body. The exhaust amount adjusting mechanism preferably increases the exhaust amount, when it is recognized that the mobile body is under a stop condition.

Here, “a stop condition” indicates a condition that possibility for opening and closing a door becomes high, such as a condition that driving of an engine is stopped, and a condition that the movement of the mobile body is stopped for not less than a predetermined time.

By such a configuration, the inside air pressure becomes near the outside air pressure when the passenger opens the door, so that the rapid opening of the door due to the air pressure difference can be restrained.

Also, the interior environment adjusting device according to the present invention includes a flow rate control valve for adjusting a supply amount of air into the inside. The environment adjusting part may be configured to adjust the supply amount of the air into the inside by adjusting an opening degree of a flow rate control valve, and execute the adjustment to make the inside air pressure into positive pressure with respect to the outside air pressure.

When the interior environment adjusting device according to the present invention is configured to supply air into the inside, it includes an outside air pressurizing mechanism for pressurizing outside air introduced from outside of the mobile body. The environment adjusting part preferably adjusts the supply amount of the pressurized outside air into the inside by adjusting the opening degree of the flow rate control valve, and executes the adjustment to make the inside air pressure into positive pressure to the outside air pressure.

In this manner, by such a configuration that the outside air is pressurized and then introduced into the inside, a large amount of air can be easily fed into the inside, so that the inside air pressure can be easily made into positive pressure to the outside air.

Also, the interior environment adjusting device according to the present invention includes an oxygen enrichment mechanism for generating oxygen-enriched air, and a flow rate control valve for adjusting a supply amount of the oxygen-enriched air in the inside from the oxygen enrichment mechanism. The environment adjusting part may be configured to adjust the supply amount of the oxygen-enriched air into the inside by adjusting the opening degree of the flow rate control valve, and execute the adjustment to make an oxygen concentration in the inside a higher concentration than in the outside air.

When the interior environment adjusting device according to the present invention is configured to generate oxygen-enriched air with an oxygen enrichment mechanism, it includes an outside air pressurizing mechanism for pressurizing outside air introduced from outside of the mobile body. The oxygen enrichment mechanism preferably generates oxygen-enriched air using the pressurized outside air.

Generally, it is known that efficiency for generating the oxygen-enriched air is improved when the oxygen-enriched air is generated using the pressurized air. Therefore, by such a configuration, energy required for generating the oxygen-enriched air can be reduced.

Also, a vehicle according to the present invention includes any of the above-mentioned interior environment adjusting device, and an internal combustion engine. The interior environment adjusting device has an oxygen enrichment mechanism for generating oxygen-enriched air, and the environment adjusting part supplies the generated oxygen-enriched air to the inside and the internal combustion engine.

The vehicle configured in such a manner can be used as physical condition maintaining and improving means, and has a new additional value other than merely moving means.

Also, the oxygen enrichment mechanism for generating the oxygen-enriched air is at relatively high costs, so it increases manufacturing costs of the vehicle, if it is mounted to the vehicle. Therefore, when the oxygen enrichment mechanism is used not only for adjusting the inside environment but also for sucking air into the internal combustion engine, not only a health promotion or fatigue recovery effect of the passenger, but also an effect for enhancing fuel efficiency and reducing the exhausted NOx, CO2, HC and the like can be generated.

Thereby, a vehicle with a high additional value friendly to the environment and leading to the reduction of consumption of resources by restraining running costs of the entire vehicle can be provided, and a new commodity value can be provided while maintaining and improving the physical condition of the passenger.

The interior environment adjusting device according to the present invention is an interior environment adjusting device for adjusting inside environment of a mobile body, and comprises a navigation device, and an environment adjusting part for adjusting at least one of the inside oxygen concentration and inside air pressure that is inside air pressure. The navigation device has a route recognition part for recognizing, a route from a first point to a second point, and a condition recognition part for recognizing a condition that gives influences to at least one of a condition of the passenger of the mobile body and the inside environment in a region including the recognized route or at least one part of the route. The environment adjusting part defines an adjusting plan of at least one of the oxygen concentration and the inside air pressure while moving through the route based on the recognized route and the condition at a passage predicted time point of the mobile body, and adjusts at least one of the oxygen concentration and the inside air pressure based on the adjusting plan.

Here, “a condition that gives influences to at least one of a condition of the passenger of the mobile body and the inside environment” includes various conditions such as an altitude, climate, temperature, a condition influencing the air pressure around the mobile body whether it is inside or outside a tunnel, whether or not it is on a highway, a distance from a current position, a road condition (for example, whether or not it is jammed), and whether or not it is at a stop position (i.e., a position at which possibility for opening a door and a window of the mobile body is high).

In this manner, the interior environment adjusting device according to the present invention is configured so that the inside environment (at least one of the inside air pressure and the oxygen concentration) can be adjusted by the environment adjusting part, so that the passenger can sufficiently take oxygen.

Additionally, the inside environment is adjusted based on the adjusting plan defined with reference to the condition on the route, not based on the condition of the current position of the mobile body. That is to say, the inside environment is adjusted based on a zone that is a route from a first point to a second point (for example, a starting point to a destination point), not based on one point that is the current position of the mobile body.

Thereby, the interior environment adjusting device according to the present invention can restrain frequent variation of the inside air pressure, and maintain and improve the physical condition due to oxygen supply at a proper timing. Accordingly, by restraining fatigue of the passenger of the mobile body, such environment that can further maintain and improve the physical condition can be provided.

Also, in the interior environment adjusting device according to the present invention, it is preferable that the condition recognition part recognizes the road condition on the recognized route, and the environment adjusting part defines the adjusting plan based on the road condition.

The road condition gives significant influences on a fatigue feeling to the passenger while driving. Thus, when the adjusting plan relating to the inside environment is defined with reference to the road condition, environment for efficiently restraining and recovering the fatigue of the passenger can be provided.

Also, in the interior environment adjusting device according to the present invention, it is preferable that the condition recognition part recognizes a driving distance that is a distance of a predetermined zone on the recognized route, and the environment adjusting part defines the adjusting plan based on the driving distance.

Here, “a predetermined zone” indicates, for example, a zone from the current position to a next stop position. The driving distance gives significant influences on a fatigue feeling to the passenger while driving. Thus, when the adjusting plan relating to the inside environment is defined with reference to the driving distance, environment for efficiently restraining and recovering the fatigue of the passenger can be provided.

In the interior environment adjusting device according to the present invention, it is preferable that the condition recognition part recognizes a driving time required for moving in a predetermined zone on the recognized route, and the environment adjusting part defines the adjusting plan to adjust at least one of the oxygen concentration and the inside air pressure only in the zone in which the driving time becomes not less than a predetermined time.

When an effect for maintaining and improving the physical condition by taking oxygen into a body is obtained, it is known that the effect becomes significantly large after a predetermined time elapses. Therefore, when the driving time is short (for example, 30 minutes or shorter), even if the inside environment is adjusted, it is difficult to obtain a sufficient effect after driving, and energy for adjusting the inside environment is consumed.

Then, when the device is configured to define the adjusting plan relating to the inside environment with reference to the driving time, such environment can be provided that the physical condition of the passenger can be efficiently maintained and improved.

In the interior environment adjusting device according to the present invention, it is preferable that the condition recognition part recognizes the air pressure at a stop position on the recognized route, and the environment adjusting part defines the adjusting plan, so that the inside air pressure approaches the air pressure at the stop position, as it approaches the stop position or when it reaches the stop position.

By such a configuration, the air pressure difference between the outside air pressure around the mobile body and the inside air pressure becomes small, so that an uncomfortable feeling felt by the passenger due to the air pressure difference can be restrained, when it reaches the stop position and the door or window is opened. Also, rapid opening of the door due to the air pressure difference can be restrained.

In the interior environment adjusting device according to the present invention, it is preferable that the condition recognition part recognizes air pressure at plural points on the recognized routes, and the environment adjusting part defines the adjusting plan, so that the inside air pressure becomes a positive pressure with respect to any of the recognized air pressure at the plural points, and becomes constant.

By such a configuration, such environment can be provided that the inside environment is made stable regardless of the route and the physical condition of the passenger can be efficiently maintained and improved.

Also, an interior environment adjusting method according to the present invention is an interior environment adjusting method for adjusting inside environment of a mobile body, and includes a step in which a route recognition part recognizes a route from a first point to a second point, a step in which a condition recognition part recognizes a condition giving influences to at least one of a passenger condition of the mobile body and the inside environment in a region including the recognized route or at least one part of the route, a step in which the environment adjusting part defines an adjusting plan of at least one of an oxygen concentration inside the mobile body while moving on the route and inside air pressure that is air pressure inside the mobile body based on the recognized route and the condition at a passage predicted time point of the mobile body, and a step in which the environment adjusting part adjusts at least one of the oxygen concentration and the inside air pressure based on the adjusting plan.

### BRIEF DESCRIPTION OF THE DRAWINGS

FIG. 1 is a drawing for schematically explaining a configuration of an interior environment adjusting device of a vehicle according to a first embodiment;

FIG. 2 is a drawing for schematically explaining a sensor mounted to the vehicle of FIG. 1;

FIG. 3 is a block diagram illustrating a configuration of the interior environment adjusting device of the vehicle of FIG. 1;

FIG. 4 is a flowchart indicating processing executed by a control part of a vehicle of FIG. 1;

FIG. 5 is a graph showing variation of inside air pressure to outside air pressure of the vehicle of FIG, 1;

FIG. 6 is a drawing for schematically explaining a configuration of an interior environment adjusting device of a vehicle according to a second embodiment;

FIG. 7 is a drawing for schematically explaining a sensor mounted to the vehicle of FIG. 6;

FIG. 8 is a block diagram illustrating a configuration of a navigation device of the vehicle of FIG. 6;

FIG. 9 is a block diagram illustrating a configuration of an interior environment adjusting device of the vehicle of FIG. 6;

FIG. 10 is a graph illustrating variation of inside air pressure to outside air pressure of the vehicle of FIG. 6; and

FIG. 11 is a flowchart indicating processing executed by a navigation device and a control part of the vehicle of FIG. 6.

### DETAILED DESCRIPTION OF THE PREFERRED EMBODIMENTS

Before a vehicle according to an embodiment is concretely explained, concepts relating to development and design of the vehicle according to the present invention will be explained.

Generally, when oxygen is sufficiently taken into a body, it is known that such an effect for maintaining and improving a physical condition can be obtained. Here, “maintenance and improvement of a physical condition” includes restraint of fatigue due to driving, recovery, restraint of drowsiness, recovery from injuries, a diet effect, dissolution of lactic acids, improvement of memory abilities, improvement of a skin condition, and the like.

When oxygen is taken into a body through a respiration organ, the amount of the taken oxygen (bound oxygen amount) depends on an amount of hemoglobin in blood bound with oxygen. Therefore, there is a risk that oxygen cannot be sufficiently taken into the body even when an oxygen supply amount is increased, according to the amount of hemoglobin. In this case, it is difficult that oxygen reaches a terminal end of a capillary vessel thinner than hemoglobin, and a sufficient effect cannot be obtained even when the amount of bound oxygen is increased.

As a result of earnest research, the present inventors have obtained a finding that the amount of dissolved oxygen directly taken in blood of a subject can be increased by making air pressure of gas existing around the subject into positive pressure to atmospheric air pressure or increasing an oxygen concentration of the gas, or satisfying both of them. Also, the inventors have obtained a finding that the oxygen concentration in atmospheric air is particularly preferably 20% or more and 40% or less and the air pressure is particularly preferably 1.1 atm or more and 2 atm or less, to increase the dissolved oxygen amount in a human body.

Conventionally, it is known that, by supplying oxygen-enriched air to an internal combustion engine such as an engine, combustion efficiency can be improved, so as to improve fuel consumption, and reduce exhausted NOx, CO2, HC and the like.

The present inventors have developed and designed the vehicle according to the present invention, based on such concepts that a new additional value as physical condition maintaining and improving means is given to the vehicle, in addition to additional values for improving fuel consumption and reducing the exhausted NOx, CO2, HC and the like as known conventionally.

Also, the mobile body to which the interior environment adjusting device is mounted according to the present invention is not limited to a vehicle, and may be anything having an inside in which passengers (including crew such as a driver, and people other than the crew such as guests) can board. Therefore, the mobile body according to the present invention includes special vehicles such as working machines, trains, ships, airplanes and the like other than common passenger vehicles illustrated in following embodiments.

### First Embodiment

Hereinafter, a vehicle V1 to which an interior environment adjusting device 1 is mounted according to a first embodiment is explained with reference to the drawings.

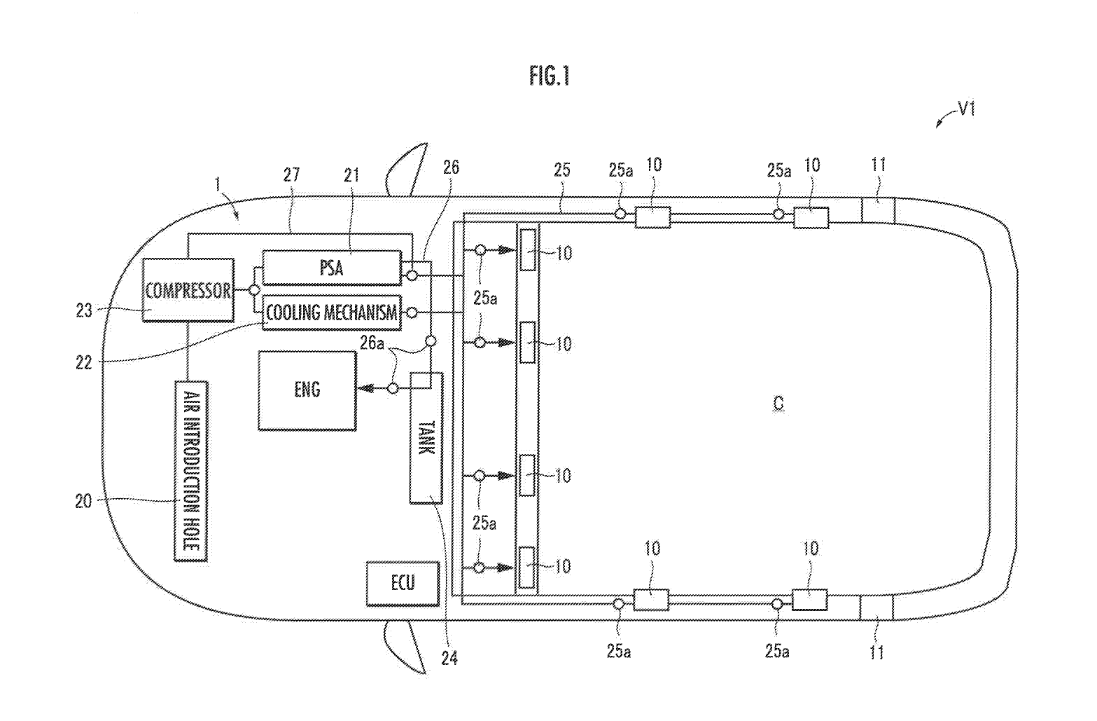

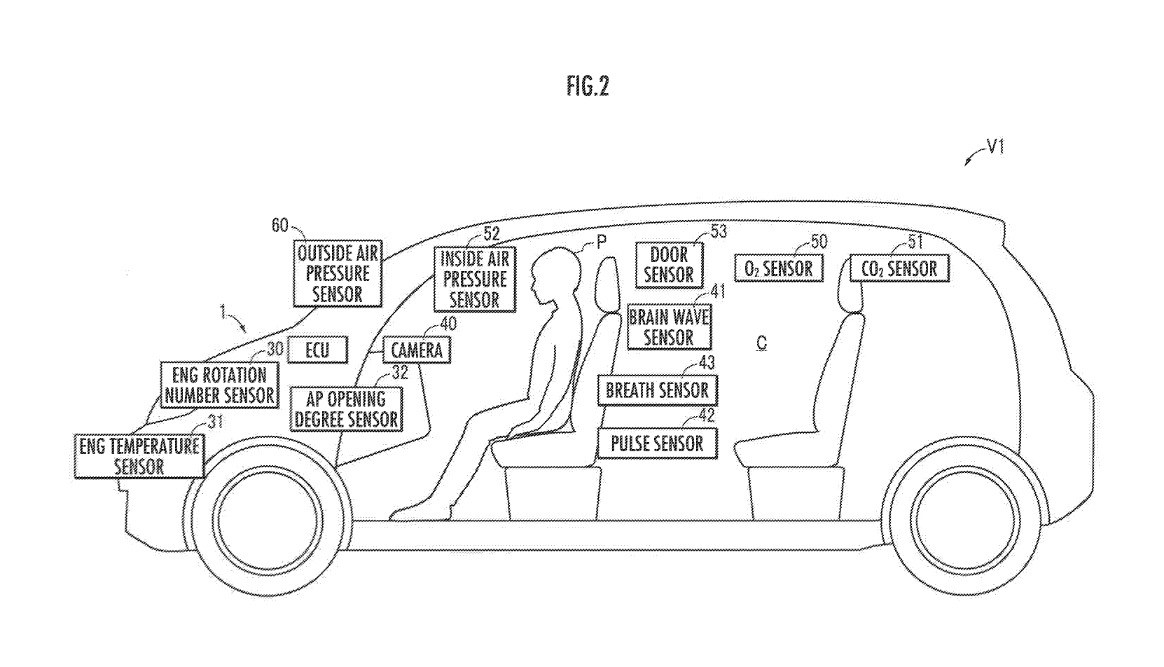

A schematic configuration of the vehicle V1 in the first embodiment will be explained with reference to FIGS. 1 and 2.

As shown in FIGS. 1 and 2, a compartment C in which a passenger P is present during moving is configured inside the vehicle Also, various sensors for detecting a condition of an engine ENG, a condition of a passenger P, and environment inside and outside the compartment C are installed in the vehicle V1.

As shown in FIG. 1, in the compartment C, plural air conditioner blowing ports 10 and pressure releasing valves 11 (exhaust amount adjusting mechanisms) are provided to adjust the environment inside the compartment C (inside).

Here, “environment” inside the compartment C indicates a condition of gas inside the compartment C, and concretely indicates inside air pressure that is air pressure inside the compartment C, and an oxygen concentration of air inside the compartment C, and the like. Also, “a condition” of the passenger P indicates presence, number, physical condition and the like of passengers P. Also, “a physical condition” indicates a degree of fatigue, a degree of drowsiness, and the like.

The air conditioner blowing ports 10 are provided at some portions inside the compartment C, and supply below-described oxygen-enriched air inside the compartment C based on signals from a below-described control part ECU.

A pressure releasing valve 11 (exhaust amount adjusting mechanism) is configured so that inside and outside of the compartment C can be communicated with each other. An opening degree of the pressure releasing valve 11. (resulting in, an exhaust amount of air from the inside of the compartment C) is adjusted based on the signals of the below-described control part ECU.

By adjusting the amount of the oxygen-enriched air introduced to inside of the compartment C from the air conditioner blowing port 10, and the opening degree of the pressure releasing valve 11, the inside air pressure of the compartment C is adjusted in the vehicle V1.

Also, the vehicle V1 comprises a driving mechanism including an engine ENG (internal combustion engine) that is a driving source as a mechanism for driving the vehicle V1 and a mechanism for adjusting the environment of the compartment C, an air introduction hole 20 for introducing outside air from outside of the vehicle 1, an oxygen enrichment mechanism 21 for generating oxygen-enriched air using one part of the introduced outside air, a cooling mechanism 22 with the other part of the introduced outside air as a refrigerant, a compressor 23 for pressurizing the introduced outside air and oxygen-enriched air (outside air pressuring mechanism, and oxygen-enriched air pressurizing mechanism), a tank 24 for storing the oxygen-enriched air, and a control part ECU for controlling the respective mechanisms based on detection results of below-described sensors.

The oxygen enrichment mechanism 21 is a PSA (Pressure Swing Adsorption) type (adsorption) oxygen enrichment mechanism. The oxygen enrichment mechanism 21 generates the oxygen-enriched air by repeating pressure-increase and pressure-reduction of the outside air introduced from the air introduction hole 20 inside a cylinder in which special zeolite having a function for adsorbing nitrogen is housed, and separating oxygen and nitrogen contained in the outside air. For example, such zeolite formed of silica, alumina and the like is used as zeolite.

One part of the oxygen-enriched air generated by the oxygen enrichment mechanism 21 is supplied to the air conditioner blowing port 10 via an inside supply path 5, and is introduced inside the compartment C via the air conditioner blowing port 10. The oxygen-enriched air introduced in this manner is used for adjusting the oxygen concentration and the inside air pressure inside the compartment C.

The amount of the oxygen-enriched air introduced inside the compartment C is controlled by a first flow rate control valve 25a provided in the inside supply path 25. The first flow rate control valve 25a is controlled by the control part ECU.

Also, the other part of the generated oxygen-enriched air is stored in the tank 24 via an intake supply path 26, and introduced to the engine ENG at a predetermined timing. Concretely, the oxygen-enriched air is introduced inside a combustion chamber in the engine ENG via an intake manifold (not shown), a supercharger (not shown) and the like of the engine ENG.

The amount of the oxygen-enriched air stored in the tank 24, and the amount of the oxygen-enriched air introduced to the engine ENG are controlled by a second flow rate control valve 26a provided in the intake supply path 26. The second flow rate control valve 26a is controlled by the control part ECU.

Also, in the first embodiment, a PSA type oxygen enrichment mechanism for easily generating oxygen-enriched air with a high oxygen concentration is used. However, the oxygen enrichment mechanism according to the present invention may be any mechanism that can generate the oxygen-enriched air.

For example, a PVSA (Pressure Vacuum Swing Adsorption) type may be adopted by further adding a vacuum pump for removing air inside a container housing zeolite to the above-described oxygen enrichment mechanism 21. When such a PVSA type is adopted, zeolite is regenerated more efficiently than a PSA type, so that ability for generating oxygen-enriched air becomes higher.

For example, an oxygen enrichment membrane type oxygen enrichment mechanism may be used. The oxygen enrichment membrane type oxygen enrichment mechanism generates oxygen-enriched air by passing air through an oxygen enrichment membrane through which oxygen can pass more than nitrogen. For example, a membrane formed of silicon and the like is used as the oxygen enrichment membrane. The oxygen enrichment membrane type oxygen enrichment mechanism is inferior to the PSA type in view of a performance for improving the oxygen concentration, but superior in view of silent property, size, and consumed power.

A cooling mechanism 22 adjusts the temperature of the air introduced inside the compartment C using the introduced outside air, and also cools the engine ENG and adjusts the temperature of the oxygen enrichment mechanism 21 (concretely, zeolite).

A compressor 23 (outside air pressurizing mechanism, oxygen-enriched air pressurizing mechanism) pressurizes the outside air introduced from the air introduction hole 20, and introduces it to the oxygen enrichment mechanism 21 and the cooling mechanism 22. By pressurizing the air introduced to the oxygen enrichment mechanism 21 and the cooling mechanism 22, efficiency for generating the oxygen-enriched air in the oxygen enrichment mechanism 21 and cooling efficiency in the cooling mechanism 22 are improved.

Also, a bypass passage 27 to an inside supply path 25 for passing the oxygen-enriched air generated by the oxygen enrichment mechanism 21 is provided from the compressor 23. Thereby, the generated oxygen-enriched air is mixed with the pressurized outside air. As a result, the air not only having a higher oxygen concentration than atmospheric air, but also under a pressurized condition is introduced inside the compartment C.

This is because the inside air pressure of the compartment C can be more easily adjusted by pressurizing the air introduced inside the compartment C than when the not-pressurized air is introduced.

The oxygen concentration and a pressurizing degree of the air introduced inside the compartment C (concretely, the supply amount to the oxygen enrichment mechanism 21 and the cooling mechanism 22 from the compressor 23 and the supply amount to the bypass passage 27) are controlled by the control part ECU.

According to the present invention, there is not necessarily a need of using a compressor as an outside air pressurizing mechanism and an oxygen-enriched air pressurizing mechanism, and any known mechanism other than a compressor may be used as long as it can pressurize air. Also, when generation ability of the oxygen enrichment mechanism is sufficiently high, and when blowing ability of an air conditioner with an air conditioner blowing port 10 is sufficiently high, there is no need of pressurizing the air, so an outside air pressurizing mechanism and an oxygen-enriched air pressurizing mechanism may be omitted.

Also, as shown in FIG. 2, plural sensors for detecting the environment inside and outside a vehicle V1 are provided on the vehicle V1.

Concretely, the vehicle V1 comprises an ENG rotation number sensor 30 for detecting the rotation number of the engine ENG, an ENG temperature sensor 31 for detecting temperature of the engine ENG, and an AP opening degree sensor 32 for detecting an opening degree of an accelerator pedal as sensors for detecting the condition of the engine ENG.

Also, the vehicle V1 comprises a camera 40 for photographing inside of a compartment C, a brain wave sensor 41 for detecting brain waves of a passenger P, a pulse sensor 42 for detecting a pulse of the passenger P, and a breath sensor 43 for detecting a breath of the passenger P, as sensors for detecting the condition of the passenger P.

The vehicle V1 comprises a O₂ sensor 50 for detecting oxygen inside the compartment C, a CO₂ sensor 51 for detecting carbon dioxide inside the compartment C, an inside air pressure sensor 52 for detecting inside air pressure that is air pressure inside the compartment C, and a door sensor 53 for detecting an opening and closing condition of a door or window (not shown), as sensors for detecting environment inside the compartment C.

The vehicle V1 comprises an outside air pressure sensor 60 for detecting the air pressure around the vehicle V1, as a sensor for detecting the environment outside the vehicle V1.

The detection results of these sensors are transmitted to the control part ECU. The control part ECU is constituted by one or more electronic circuit units including a CPU, a RAM, a ROM, an interface circuit and the like.

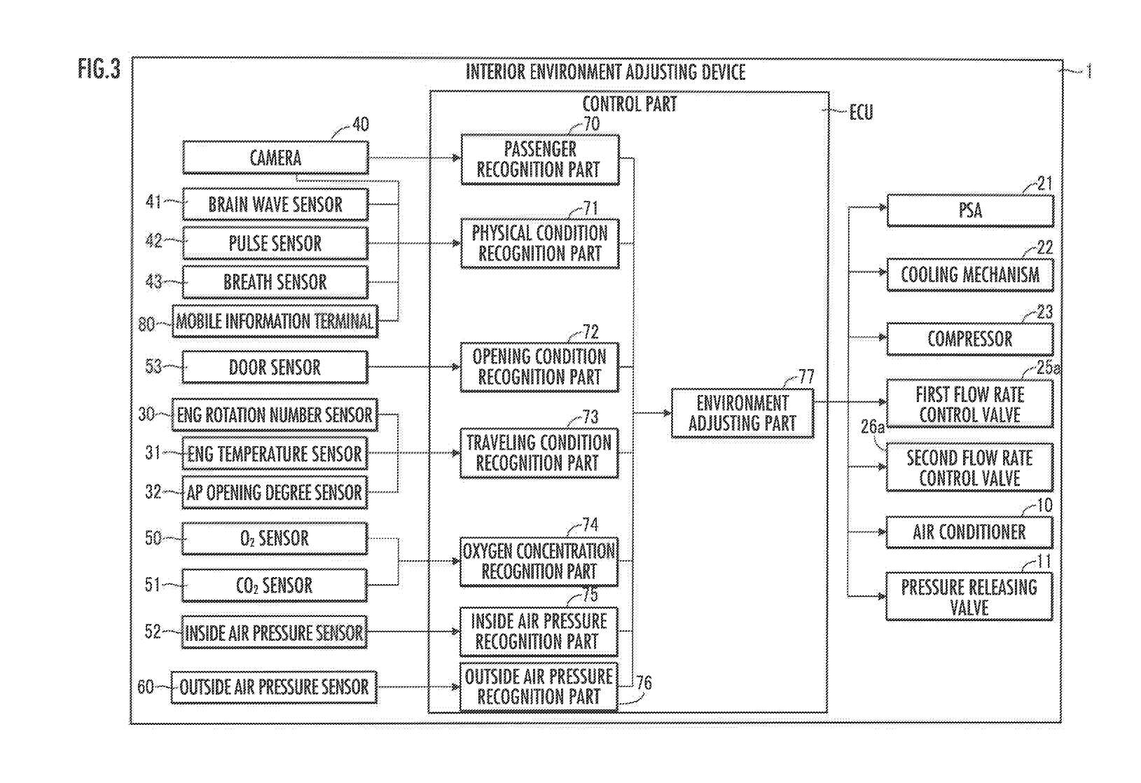

As shown in FIG. 3, the control part ECU comprises a passenger recognition part 70, a physical condition recognition part 71, an opening condition recognition part 72, a traveling condition recognition part 73, an oxygen concentration recognition part 74, an inside air pressure recognition part 75, an outside air pressure recognition part 76, and an environment adjusting part 77, as functions realized by a mounted hardware configuration or program. Processing by each of the function parts is sequentially executed.

In the vehicle V1, the environment adjusting part 77 adjusts the environment inside the compartment C (i.e., the supply amount of gas to inside of the compartment C), and a supply amount of the oxygen-enriched air to the engine ENG, based on the condition of the passenger P recognized by the passenger recognition part 70, the physical condition recognition part 71, the opening condition recognition part 72, the traveling condition recognition part 73, the oxygen concentration recognition part 74, the inside air pressure recognition part 75, and the outside air pressure recognition part 76, and the environment inside and outside the vehicle V1.

The passenger recognition part 70 recognizes the presence of the passenger P inside the compartment C based on signals from the camera 40. The environment adjusting part 77 does not adjust the environment inside the compartment C, when it is recognized that the passenger P is not present inside the compartment C.

Thereby, in the vehicle V1, the difference between the environment inside the compartment C and the environment outside the vehicle V1 under an unmanned condition is prevented, so that a phenomenon due to the difference of the environment (for example, noises in ears, and variation of a force required for opening and closing a door) is restrained and giving a feeling of discomfort to the passenger P during boarding can be inhibited.

Although an auto-start function and the like for adjusting the inside environment in advance before the passenger boards are not adopted to the vehicle V1, when they are adopted, excessive adjustment of the inside environment can be prevented by starting the adjustment of the inside environment based on the presence of the passenger. Thereby, even when the auto-start function is adopted, waste consumption of the energy for adjusting the inside environment can be prevented.

Also, the passenger recognition part 70 recognizes the number of the passengers P inside the compartment C based on the signals from the camera 40. The environment adjusting part 77 determines to what degree to adjust the environment inside the compartment C based on the number of the recognized passengers P.

This is because the degree of variation of the environment inside the compartment C (in particular, variation of the oxygen concentration) is significantly influenced by the number of the passengers P inside the compartment C (i.e., the amount of oxygen consumed by the respiration of the passengers P), so the amount of the consumed oxygen must be considered to adjust the inside environment.

Here, the passenger recognition part according to the present invention is not limited to a part for recognizing a passenger based on signals from a camera, and may be a part for recognizing the passenger based on an existing passenger recognition measure (for example, a method for detecting a weight and movement of a seat, a method for detecting usage of a seatbelt, or a method in combination thereof).

A method for adjusting the inside of the compartment C based on the number of the passengers P includes, for example, a method for estimating a reduction amount of oxygen inside the compartment C per hour, and determining a supply amount of oxygen-enriched air supplied to the inside of the compartment C based on the reduction amount by referring to a data table preset from the number of the passengers P.

The physical condition recognition part 71 recognizes the physical condition of the passenger P, based on the signals from the camera 40, the brain wave sensor 41, the pulse sensor 42 and the breath sensor 43, and biological information acquired via the mobile information terminal 80 of the passenger P. For example, it is recognized whether the passenger P is sleeping or drowsy, based on the signals from the camera 40.

The environment adjusting part 77 determines whether or not to adjust the environment inside the compartment C, and to what degree to adjust it, based on whether or not the physical condition of the recognized passenger P is a predetermined physical condition.

Here, “a predetermined physical condition” indicates a physical condition determined that there is a need of improving and enhancing the physical condition. For example, it indicates such a physical condition that a degree of fatigue or a degree of drowsiness of the recognized passenger P exceeds a threshold. A reference for determining whether or not it is a predetermined physical condition may be appropriately set by a designer of the vehicle V.

Also, the physical condition recognition part according to the present invention may be a part for the passenger P himself to appropriately input the physical condition of the passenger P, other than a part for automatically recognizing the physical condition of the passenger P as described above.

There may be no need of maintaining and improving the physical condition by the oxygen-enriched air, or, conversely, there may be a larger need depending on the physical condition of the passenger P.

Then, the environment inside the compartment C is adjusted, and the supply amount of the oxygen-enriched air to the engine ENG is adjusted, based on the physical condition of the passenger (i.e., limited to a timing at which there is a need of maintaining and improving the physical condition).

Thereby, the oxygen-enriched air can be used at a timing appropriate to the passenger P. Also, the excessive adjustment of the environment inside the compartment C is prevented, so that the waste consumption of energy for adjusting the environment inside the compartment C can be prevented.

Also, in the vehicle V1 in the first embodiment, the physical condition recognition part 71 recognizes the physical condition of the passenger P also with reference to the biological information transmitted from the mobile information terminal of the passenger P, in order to effectively maintain and improve the physical condition by properly grasping the physical condition of the passenger P (thus, setting the environment inside the compartment C appropriate to the passenger P) by recognizing the physical condition of the passenger P with reference to not only a condition that the passenger boards the vehicle V1, but also a condition before the passenger boards the vehicle V1.

Here, “a mobile information terminal” is something that can acquire information relating to the physical condition of the passenger P outside the vehicle V1, such as a mobile phone, a wearable terminal, and a laptop computer, and may be something that has a communication function capable of transmitting the information relating to the physical condition of the passenger to the physical condition recognition part 71.

However, the interior environment adjusting device according to the present invention is not limited to such a configuration, and may recognize the physical condition of the passenger only by the signals detected by sensors mounted to the vehicle and recognize the physical condition of the passenger only by the biological information transmitted from the mobile information terminal.

The opening condition recognition part 72 recognizes whether or not at least any one of a window and a door (not shown) of the vehicle V1 is opened, based on the signals from the door sensor 53. The environment adjusting part 77 does not adjust the environment inside the compartment C (in particular, adjust the inside air pressure), when it is recognized that at least any one of the window and the door is opened by the opening condition recognition part 72.

This is because airtightness inside the compartment C becomes extremely low, so there is a need of a large amount of energy to adjust the inside air pressure of the compartment C, when at least any one of the window and the door is opened.

The traveling condition recognition part 73 recognizes the traveling condition of the vehicle V1, based on the signals from the ENG rotation number sensor 30, the ENG temperature sensor 31, and an AP opening degree sensor 32. The environment adjusting part 77 adjusts the supply amount of the oxygen-enriched air to the inside of the compartment C, and the supply amount to the engine ENG, according to the traveling condition of the recognized vehicle V1.

Concretely, the supply amount of the oxygen-enriched air to the engine ENG is made larger than the supply amount to the inside of the compartment C, in at least any one of a low-temperature driving (starting) condition that the temperature of the engine ENG is lower than predetermined temperature, and a high rotation and high load condition that the rotation number of the engine ENG is higher than a predetermined rotation number and a load of the engine ENG is higher than a predetermined load.

When the engine ENG is under at least one of the low temperature driving (starting) condition and the high rotation and high load condition, an air-fuel consumption rich control for increasing an intake amount and a fuel injection amount supplied to the engine ENG to obtain a torque required for the engine ENG is generally done, thereby temporarily deteriorating the fuel consumption.

In the vehicle V1, in such a case, a larger amount of the oxygen-enriched air is supplied to an internal consumption engine, so as to restrain deterioration of the fuel consumption by making combustion better, and to provide faster warming and reduced emissions.

Also, for example, under a high rotation and low load condition that the rotation number of the engine ENG is higher than the predetermined rotation number and the load of the engine ENG is lower than the predetermined load, the supply amount of the oxygen-enriched air inside the compartment C is made larger than the supply amount into the engine ENG.

This is because, when the engine ENG is under the high rotation and low load condition, the torque applied to the engine ENG is low, so that the fuel consumption can be made much better by increasing an intake amount and promoting lean combustion.

In such a case, when one part of the oxygen-enriched air generated inside the compartment C is supplied, the oxygen-enriched air can be used for maintaining and improving the physical condition of the passenger P inside the compartment C, while maintaining a condition that the combustion is made better and the fuel consumption is improved.

Here, “a load” of the engine ENG is a value defined by a required torque and a required intake amount. Also, the values of “predetermined temperature”, “a predetermined rotation number” and “a predetermined load” are appropriately set according to a performance of component apparatuses of the vehicle V1 such as the engine ENG.

Also, the traveling condition recognition part 73 recognizes whether or not the vehicle V1 is under a stop condition. The environment adjusting part 77 starts exhausting of the air inside the compartment C by releasing the pressure releasing valve 11 when it is recognized by the traveling condition recognition part 73 that the vehicle V1 is under a stop condition.

Here, “a stop condition” indicates a condition that possibility for opening and closing the door is high, such as a condition that driving of the engine is stopped and a condition that the movement of the mobile body stops for a predetermined time or more.

When the vehicle V1 becomes under a stop condition, it is considered that possibility that the passenger P opens the door thereafter is high. Therefore, when it is recognized as under the stop condition, the vehicle V1 is configured to make the inside air pressure of the compartment C near the outside air pressure around the vehicle V1 in preparation to the opening of the door. Thereby, the rapid opening of the door is restrained by the air pressure difference between the inside air pressure of the compartment C and the outside air pressure around the vehicle V1.

The oxygen concentration recognition part 74 recognizes the oxygen concentration inside the compartment C based on the signals from the O₂ sensor 50 and the CO₂ sensor 51. The inside air pressure recognition part 75 recognizes the inside air pressure that is air pressure inside the compartment C based on the signals from the inside air pressure sensor 52. Also, the outside air pressure recognition part 76 recognizes the outside air pressure that is air pressure around the vehicle V1, based on the signals from the outside air pressure sensor 60.

The environment adjusting part 77 adjusts the environment inside the compartment C (i.e., a condition of gas, concretely, oxygen concentration and inside air pressure), and the supply amount of the oxygen-enriched air to the engine ENG based on the condition of the recognized passenger P and the environment inside and outside the vehicle V1.

Concretely, the environment adjusting part 77 adjusts a generation amount of oxygen-enriched air by the oxygen enrichment mechanism 21, temperature of the oxygen-enriched air by the cooling mechanism 22, a degree of pressurizing the oxygen-enriched air and the outside air by the compressor 23, the supply amount of the oxygen-enriched air inside the compartment C by the first flow rate control valve 25a and the air conditioner blowing port 10, the supply amount of the oxygen-enriched air to the engine ENG by the second flow rate control valve 26a, and the exhaust amount of the air from inside of the compartment C by the pressure releasing valve 11.

In the vehicle V1 in the first embodiment, the environment adjusting part 77 adjusts the environment inside the compartment C, based on the signals from the passenger recognition part 70, the physical condition recognition part 71, the opening condition recognition part 72, the traveling condition recognition part 73, the oxygen concentration recognition part 74, the inside air pressure recognition part 75, and the outside air pressure recognition part 76.

The interior environment adjusting device according to the present invention is not necessarily limited to such a configuration. For example, when the device is configured to always adjust the environment inside the compartment and the supply amount of the oxygen-enriched air to the internal combustion engine during driving a vehicle based on a predefined setting, any or all of the passenger recognition part, the physical condition recognition part, the opening condition recognition part, the traveling condition recognition part, the oxygen concentration recognition part, the inside air pressure recognition part, and the outside air pressure recognition part may be omitted.

In the vehicle V1, the interior environment adjusting device 1 is configured by the above-mentioned sensors, the control part ICU (also, its respective function parts), the oxygen enrichment mechanism 21, the cooling mechanism 22, the compressor 23, the first flow rate control valve 25a, the second flow rate control valve 26a, the air conditioner blowing port 10, and the pressure releasing valve 11.

In the vehicle V1, processing for adjusting the environment inside the compartment C and the supply amount of the oxygen-enriched air to the engine ENG is started by the interior environment adjusting device 1 from when the engine ENG of the vehicle V1 is driven or when the movement of the vehicle V1 is started.

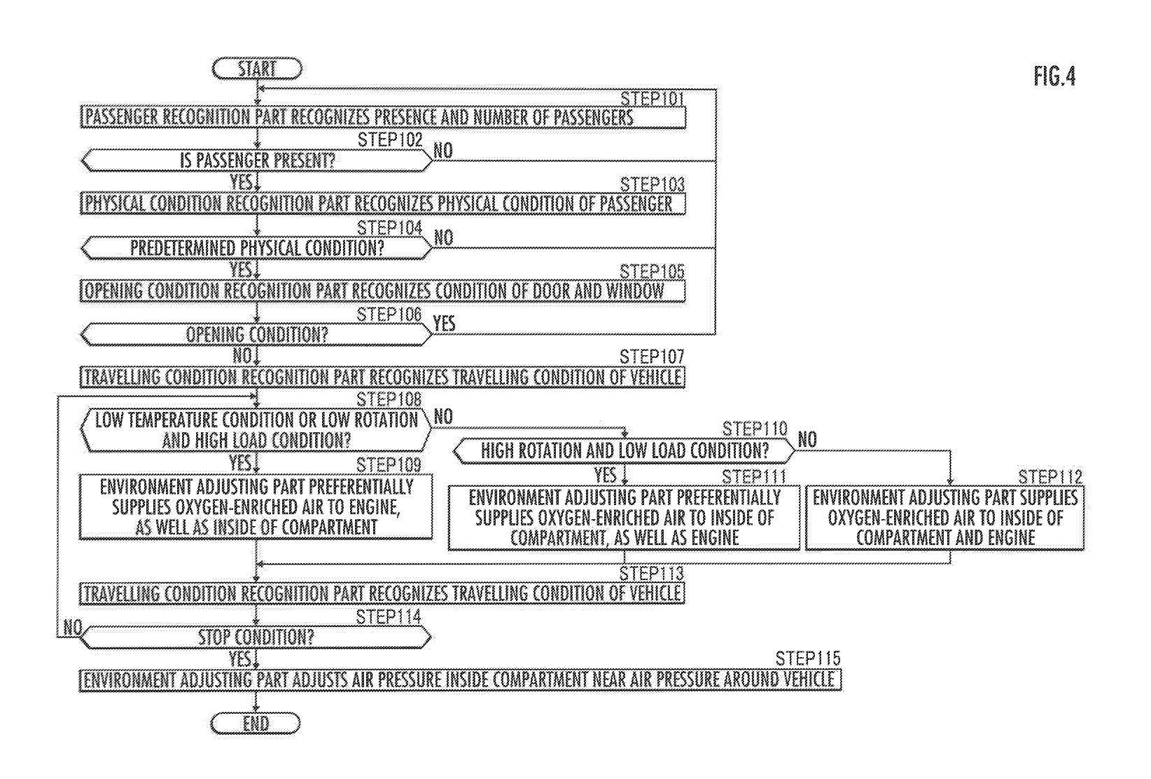

Then, with reference to FIG. 3 to FIG. 5, processing (interior environment adjusting method) executed for adjusting the environment inside the compartment C by each function part of the control part ECU of the interior environment adjusting device 1 will be explained. FIG. 4 is a flowchart indicating the processing executed by the control part ECU.

In this processing, the passenger recognition part 70 first recognizes the presence and the number of the passengers P inside the compartment C based on the signals from the camera 40 (FIG. 4/STEP 101).

When the passenger recognition part 70 recognizes that there is no passenger P inside the compartment C (FIG. 4/NO in STEP 102), it is returned to STEP 101, and the passenger recognition part 70 recognizes the presence and the number of the passengers P inside the compartment C again.

When the passenger recognition part 70 recognizes that there are the passengers P inside the compartment C (FIG. 4/YES in STEP 102), the physical condition recognition part 71 recognizes the physical condition of the passenger P based on the signals from the camera 40, the brain wave sensor 41, the pulse sensor 42 and the breath sensor 43, and the biological information acquired via the mobile information terminal 80 of the passenger P (FIG. 4/STEP 103).

When the physical condition recognition part 71 recognizes that the physical condition is not a predetermined physical condition (for example, such a physical condition determined as requiring improvement and enhancement of the physical condition) (FIG. 4/NO in STEP 104), it is returned to STEP 101, and the passenger recognition part 70 recognizes the presence and the number of the passengers P inside the compartment C again.

At this time, it may be configured so that it is not returned to STEP 101 and is returned to STEP 103, and the physical condition recognition part 71 recognizes the physical condition of the passengers P again after the predetermined time elapses.

When the physical condition recognition part 71 recognizes that the physical condition is a predetermined physical condition (FIG. 4/YES in STEP 104), the opening condition recognition part 72 recognizes the condition of the window and the door of the vehicle V1 based on the signals from the door sensor 53 (FIG. 4/STEP 105).

When the opening condition recognition part 72 recognizes that any one of the door and the window is under an opening condition (FIG. 4/YES in STEP 106), it is returned to STEP 101, and the passenger recognition part 70 recognizes the presence and the number of the passengers P inside the compartment C again.

At this time, it may be configured so that it is not returned to STEP 101 and is returned to STEP 105, and the physical condition recognition part 71 recognizes the physical condition of the passengers P again after the predetermined time elapses. Also, it may be configured so that it is returned to STEP 103, and the physical condition recognition part 71 recognizes the physical condition of the passengers P again after the predetermined time elapses.

When the opening condition recognition part 72 recognizes that the door and the window are not under an opening condition (FIG. 4/NO in STEP 106), the traveling condition recognition part 73 recognizes the traveling condition of the vehicle V1 based on the signals from the ENG rotation number sensor 30, the ENG temperature sensor 31, and the AP opening degree sensor 32 (FIG. 4/STEP 107).

When the traveling condition recognition part 73 recognizes that the engine ENG is under at least any one of a low temperature condition and a low rotation and high load condition (FIG. 4/YES in STEP 108), the environment adjusting part 77 starts the adjustment of the environment inside the compartment C and the supply amount of the oxygen-enriched air to the engine ENG by supplying the oxygen-enriched air to the inside of the compartment C while preferentially supplying it to the engine ENG (FIG. 4/STEP 109).

When the traveling condition recognition part 73 recognizes that the engine ENG is not under any of a low temperature condition and a low rotation and high load condition (FIG. 4/NO in STEP 108) and recognizes that the engine is under a high rotation and low load condition (FIG. 4/YES in STEP 110), the environment adjusting part 77 starts the adjustment of the environment inside the compartment C and the supply amount of the oxygen-enriched air to the engine ENG by supplying the oxygen-enriched air to the engine ENG while preferentially supplying it to the inside of the compartment C (FIG. 4/STEP 111).

When the traveling condition recognition part 73 recognizes that the engine ENG is not under any of a low temperature condition and a low rotation and high load condition (FIG. 4/NO in STEP 108) and recognizes that the engine is not under the high rotation and low load condition (FIG. 4/NO in STEP 110), the environment adjusting part 77 starts the adjustment of the environment inside the compartment C and the supply amount of the oxygen-enriched air to the engine ENG by supplying the oxygen-enriched air to the inside of the compartment C and the engine ENG according to the predefined supply amount (FIG. 4/STEP 112).

In adjusting the environment in STEP 109, STEP 111 and STEP 112, concretely, the environment adjusting part 77 first determines the environment to be realized inside the compartment C based on the number of the recognized passengers P and the physical conditions of the passengers P, and then recognizes the supply amount of the oxygen-enriched air required for realizing the environment inside the compartment C. Also, the environment adjusting part 77 recognizes the supply amount of the oxygen-enriched air to be supplied to the engine ENG based on the traveling condition of the recognized vehicle V1.

Then, the environment adjusting part 77 supplies the oxygen-enriched air to the inside of the compartment C and the engine ENG while adjusting the supply amounts to them, by adjusting the opening degree of the first flow rate control valve 25a of the inside supply path 25 and the opening degree of the second flow rate control valve 26a of the intake supply path 26.

In this manner, the environment adjusting part 77 adjusts the environment inside the compartment C (i.e., the oxygen concentration, and inside air pressure that is air pressure inside the compartment C), and the supply amount of the oxygen-enriched air to the engine ENG.

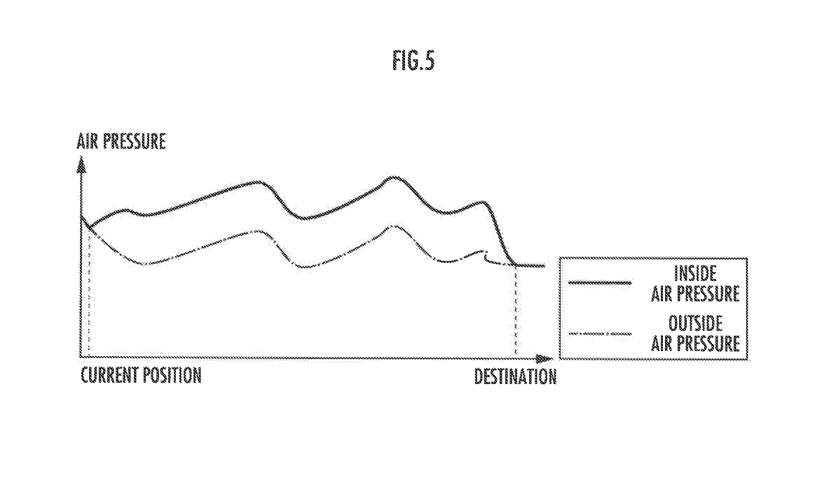

Here, in the vehicle V1, the inside air pressure that is air pressure inside the compartment C (a value indicated by a solid line in FIG. 5) is adjusted to be positive pressure to the outside air pressure (a value indicated by a dotted line in FIG. 5) that is air pressure around the vehicle V1 (for example, the oxygen concentration is 20% or more and 40% or less and the inside air pressure is 1.1 atm or more and 2 atm or less) within a range effective to improve the physical condition, and adjusted so that the difference between the outside air pressure and the inside air pressure becomes constant.

This is to restrain vibration and noise due to variation, because force for deforming the vehicle body is applied to the vehicle body according its variation, when the differential pressure between the inside air pressure and the outside air pressure varies. When means configured to separately restrain deformation of the vehicle, or the vibration and noise is provided, there is not necessarily a need of adjustment so that the differential pressure becomes constant.

Also, as shown in FIG. 5, the inside air pressure is increased step by step, so as to gradually approach a target air pressure from when the adjustment is started (i.e., a current position). This is because there is a risk that noise in ears is caused to the passenger and an uncomfortable feeling is given if the inside air pressure is rapidly increased. When the target air pressure is not so different from the current inside air pressure, the inside air pressure may be immediately adjusted to the target air pressure.

Return to the description of the processing executed by each function part of the control part ECU shown in the flowchart of FIG. 4. After the processing in STEP 109, STEP 111 and STEP 112, the traveling condition recognition part 73 recognizes the traveling condition of the vehicle V1 again, based on the signals from the ENG rotation number sensor 30, the ENG temperature sensor 31 and the AP opening degree sensor 32 (FIG. 4/STEP 113).

When the traveling condition recognition part 73 recognizes that the vehicle V1 is not under a stop condition (FIG. 4/NO in STEP 114), it is returned to STEP 108, and the traveling condition recognition part 73 determines the traveling condition of the vehicle V1 (whether or not the engine ENG is under at least any one of the low temperature condition and the low rotation and high load condition, or under the low temperature condition) again.

When the traveling condition recognition part 73 recognizes that the vehicle V1 is under a stop condition (FIG. 4/YES in STEP 114), the environment adjusting part 77 adjusts the inside air pressure that is air pressure inside the compartment C to approach the outside air pressure that is air pressure around the vehicle V1 by making the pressure releasing valve 11 under the releasing condition (FIG. 4/STEP 115).

Also, as shown in FIG. 5, the inside air pressure is decreased step by step, so as to gradually approach the outside air pressure as the vehicle approaches the destination from a predetermined time (for example, a time at a predetermined distance from a destination). This is because there is a risk that an uncomfortable feeling is given to the passenger if the inside air pressure is rapidly decreased. When the outside air pressure is not so different from the current inside air pressure, the inside air pressure may be immediately adjusted to the outside air pressure.

Then, the inside air pressure becomes almost the same as the outside pressure and the door of the vehicle V1 is opened, and the control part ECU completes this processing.

As explained above, the oxygen enrichment mechanism 21 is mounted to the vehicle V1, and the environment inside the compartment C is adjusted and the intake amount of the engine ENG is adjusted (thereby, the fuel consumption is improved, and the exhausted NOx, CO₂, HC and the like are reduced) by the generated oxygen-enriched air.

Thereby, as is similar to a conventional vehicle to which the oxygen enrichment mechanism is mounted, in addition to additional values for improving fuel consumption and reducing the exhausted NOx, CO₂, HC and the like, a new additional value as physical condition maintaining and improving means is provided in the vehicle V1. The new additional value is provided in a form that can be easily felt by the passenger P.

### Second Embodiment

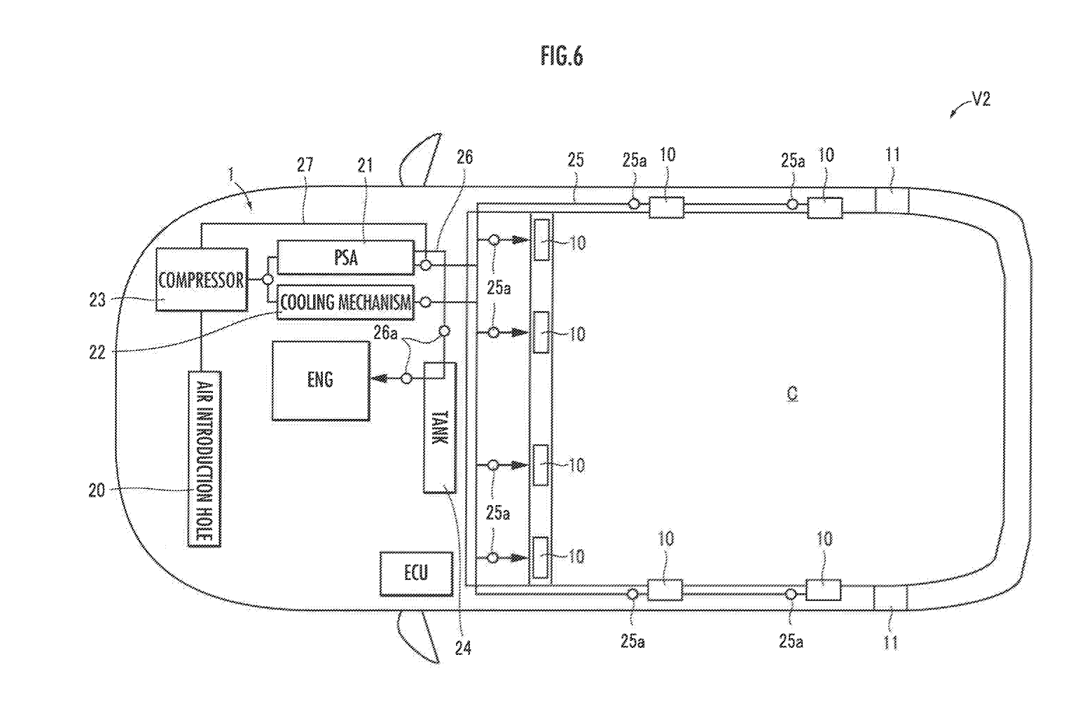

With reference to FIG. 6 to FIG. 11, a vehicle 2 to which the interior environment adjusting device 1 according to a second embodiment is mounted, will be explained as follows. The components similar to or corresponding to those of the vehicle V1 in the first embodiment have the same numerals and symbols.

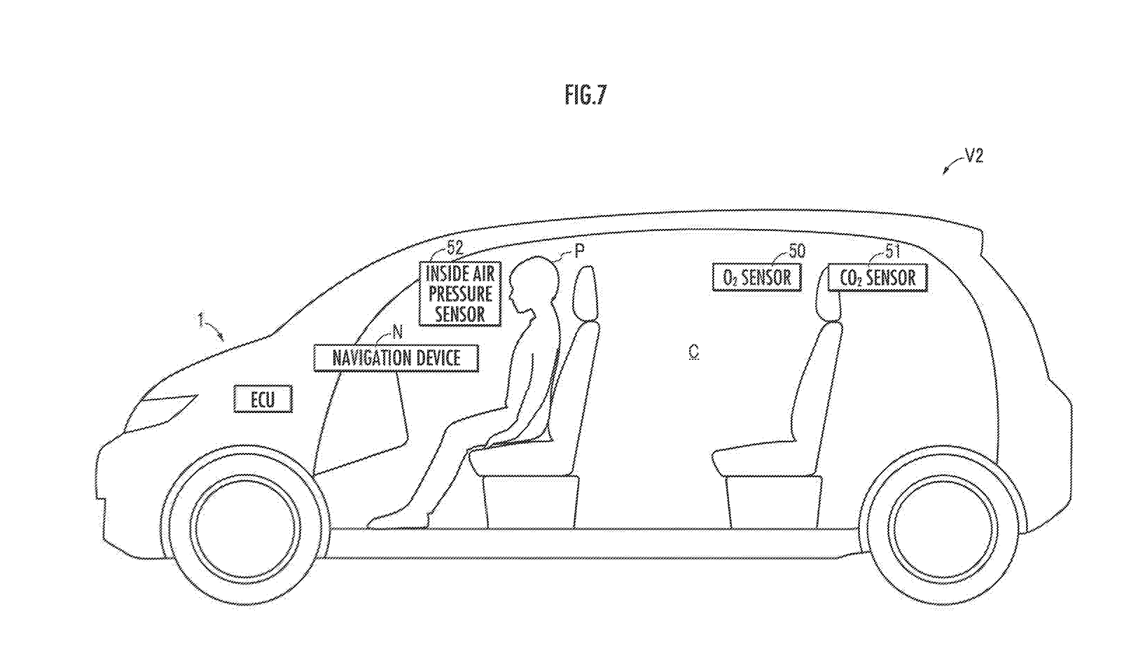

First, with reference to FIG. 6 and FIG. 7, a schematic configuration of the vehicle V2 in the second embodiment will be explained.

As shown in FIG. 6 and FIG. 7, the vehicle V2 is provided with a compartment C inside which a passenger P is present during moving. Also, the vehicle V2 is provided with various sensors for detecting the environment inside the compartment C, and a navigation device N.

As shown in FIG. 6, the compartment C is provided with plural air conditioner blowing ports 10 and a pressure releasing valve 11 (an exhaust amount adjusting mechanism) for adjusting the (inside) environment inside the compartment C.

Here, “environment” inside the compartment C indicates a condition of gas inside the compartment C, concretely inside air pressure that is air pressure inside the compartment C, an oxygen concentration of the air inside the compartment C, and the like.

The air conditioner blowing ports 10 are provided at some portions inside the compartment C, and supply a below-described oxygen-enriched air to the inside of the compartment C based on the signals from a below-described control part ECU.

The pressure releasing valve 11 (exhaust amount adjusting mechanism) is configured to freely communicate the inside and the outside of the compartment C with each other. The opening degree of the pressure releasing valve 11 (thereby, the exhaust amount of the air from the inside of the compartment C) is adjusted based on the signals from the below-described control part ECU.

In the vehicle V2, the inside air pressure of the compartment C is adjusted by adjusting the amount of the oxygen-enriched air introduced inside the compartment C from the air conditioner blowing ports 10 and the opening degree of the pressure releasing valve 11.

The vehicle V2 comprises a driving mechanism including an engine ENG (internal combustion engine) that is a driving source, an air introduction hole 20 for introducing outside air from the outside of the vehicle V2, an oxygen enrichment mechanism 21 for generating the oxygen-enriched air using one part of the introduced outside air, a cooling mechanism 22 for making the other part of the introduced outside air into a refrigerant, a compressor 23 (outside air pressurizing mechanism, oxygen enriched-air pressurizing mechanism) for pressurizing the introduced outside air and oxygen-enriched air, a tank 24 for storing the oxygen-enriched air, and a control part ECU for controlling each mechanism based on detection results of below-described sensors, as a mechanism for driving the vehicle V2 and a mechanism for adjusting the environment of the compartment C.

The oxygen enrichment mechanism 21 is a PSA (Pressure Swing Adsorption) type (adsorption) oxygen enrichment mechanism. The oxygen enrichment mechanism 21 generates the oxygen-enriched air by repeating pressure-increase and pressure-reduction of the outside air introduced from the air introduction hole 20 inside a cylinder in which special zeolite having a function for adsorbing nitrogen is housed, and separating oxygen and nitrogen contained in the outside air. For example, such zeolite formed of silica, alumina and the like is used as zeolite.

One part of the oxygen-enriched air generated by the oxygen enrichment mechanism 21 is supplied to the air conditioner blowing port 10 via an inside supply path 25, and is introduced inside the compartment C via the air conditioner blowing port 10. The oxygen-enriched air introduced in this manner is used for adjusting the oxygen concentration and the inside air pressure inside the compartment C.

The amount of the oxygen-enriched air introduced inside the compartment C is controlled by a first flow rate control valve 25a provided in the inside supply path 25. The first flow rate control valve 25a is controlled by the control part ECU.

Also, the other part of the generated oxygen-enriched air is stored in the tank 24 via an intake supply path 26, and introduced to the engine ENG at a predetermined timing. Concretely, the oxygen-enriched air is introduced inside a combustion chamber in the engine ENG via an intake manifold (not shown), a supercharger (not shown) and the like of the engine ENG.

The amount of the oxygen-enriched air stored in the tank 24, and the amount of the oxygen-enriched air introduced to the engine ENG are controlled by a second flow rate control valve 26a provided in the intake supply path 26. The second flow rate control valve 26a is controlled by the control part ECU.

Also, in the second embodiment, a PSA type oxygen enrichment mechanism for easily generating oxygen-enriched air with a high oxygen concentration is used. However, the oxygen enrichment mechanism according to the present invention may be any mechanism that can generate the oxygen-enriched air.

For example, a PVSA (Pressure Vacuum Swing Adsorption) type may be adopted by further adding a vacuum pump for removing air inside a container housing zeolite to the above-described oxygen enrichment mechanism 21. When such a PVSA type is adopted, zeolite is regenerated more efficiently than a PSA type, so that ability for generating oxygen-enriched air becomes higher.

For example, an oxygen enrichment membrane type oxygen enrichment mechanism may be used. The oxygen enrichment membrane type oxygen enrichment mechanism generates oxygen-enriched air by passing air through an oxygen enrichment membrane through which oxygen can pass more than nitrogen. For example, a membrane formed of silicon and the like is used as the oxygen enrichment membrane. The oxygen enrichment membrane type oxygen enrichment mechanism is inferior to the PSA type in view of a performance for improving the oxygen concentration, but superior in view of silent property, size, and consumed power. A cooling mechanism 22 adjusts the temperature of the air introduced inside the compartment C using the introduced outside air, and also cools the engine ENG and adjusts the temperature of the oxygen enrichment mechanism 21 (concretely, zeolite).

A compressor 23 (outside air pressurizing mechanism, oxygen-enriched air pressurizing mechanism) pressurizes the outside air introduced from the air introduction hole 20, and introduces it to the oxygen enrichment mechanism 21 and the cooling mechanism 22. By pressurizing the air introduced to the oxygen enrichment mechanism 21 and the cooling mechanism 22, efficiency for generating the oxygen-enriched air in the oxygen enrichment mechanism 21 and cooling efficiency in the cooling mechanism 22 are improved.

Also, a bypass passage 27 to an inside supply path 25 for passing the oxygen-enriched air generated by the oxygen enrichment mechanism 21 is provided from the compressor 23. Thereby, the generated oxygen-enriched air is mixed with the pressurized outside air. As a result, the air not only having a higher oxygen concentration than atmospheric air, but also under a pressurized condition is introduced inside the compartment C.

This is because the inside air pressure of the compartment C can be more easily adjusted by pressurizing the air introduced inside the compartment C than when the not-pressurized air is introduced.

The oxygen concentration and a pressurizing degree of the air introduced inside the compartment C (concretely, the supply amount to the oxygen enrichment mechanism 21 and the cooling mechanism 22 from the compressor 23 and the supply amount to the bypass passage 27) are controlled by the control part ECU.

According to the present invention, there is not always a need of using a compressor as an outside air pressurizing mechanism and an oxygen-enriched air pressurizing mechanism, and any known mechanism other than a compressor may be used as long as it can pressurize air. Also, when generation ability of the oxygen enrichment mechanism is sufficiently high, and when blowing ability of an air conditioner with an air conditioner blowing port 10 is sufficiently high, there is no need of pressurizing the air, so an outside air pressurizing mechanism and an oxygen-enriched air pressurizing mechanism may be omitted.

Also, as shown in FIG. 7, the vehicle V2 comprises an O₂ sensor 50 for detecting oxygen inside the compartment C, a CO₂ sensor 51 for detecting carbon dioxide inside the compartment C, and an inside air pressure sensor 52 for detecting inside air pressure that is air pressure inside the compartment C, as sensors for detecting the environment inside the compartment C.

The vehicle V2 comprises a navigation device N. The navigation device N is configured by one or more electronic circuit units including CPU, RAM, ROM, an interface circuit and the like.

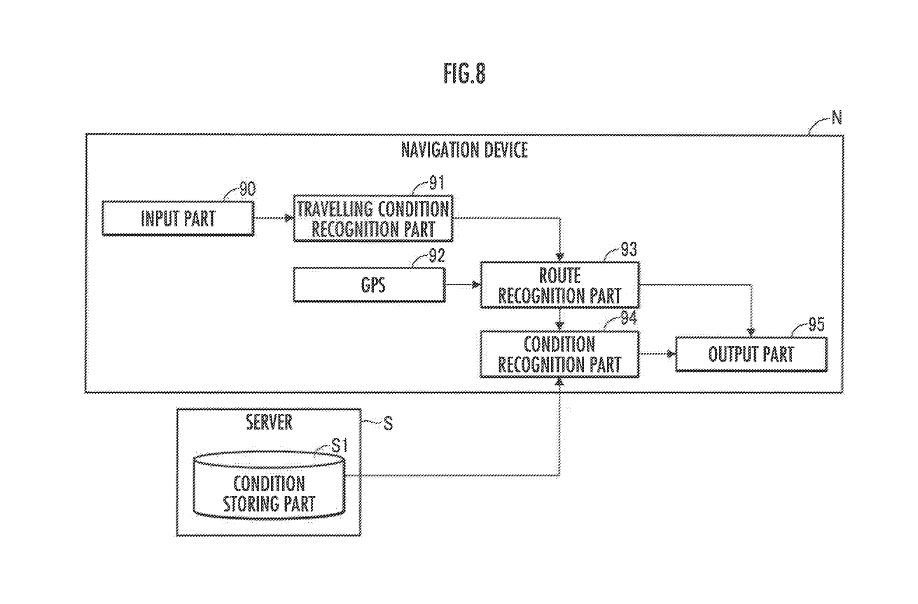

As shown in FIG. 8, the navigation device N comprises an input part 90 for inputting information by the passenger P, a traveling condition recognition part 91 for recognizing a traveling condition, a GPS 92 for recognizing the current positional information of the vehicle V2, a route recognition part 93 for recognizing a route from a first point to a second point, a condition recognition part 94 for recognizing a condition that gives influences to at least one of a condition of the passenger P and the environment inside the compartment C in a region including the recognized route or at least one part of the route, and an output part 95 for notifying information to the passenger P, as functions realized by a mounted hardware component or a program.

Here, “a traveling condition” includes various conditions used in determining a route such as designated first and second points (for example, destination, transition, stop position), a required time desired by the passenger P, a road condition and the like.

Here, “a condition that gives influences to at least one of a condition of the passenger P and the environment inside the compartment C” includes various conditions such as an altitude, climate, temperature, a condition influencing the air pressure around a mobile body whether it is inside or outside a tunnel, whether or not it is on a highway, a distance from a current position, a road condition (for example, whether or not it is jammed), and whether or not it is at a stop position a position at which possibility for opening a door and a window of the vehicle V2 is high).

The input part 90 is an input apparatus configured by, for example, a touch panel and various buttons, a microphone for sound input, and a combination thereof. The passenger P inputs the information such as desired destination, stop position, characteristic of a route (shortness of a moving time, easiness of driving, low costs and the like are preferential), via the input part 90.

The traveling condition recognition part 91 recognizes a traveling condition desired by the passenger P based on the information input via the input part 90.

The route recognition part 93 recognizes the route to the destination based on the traveling condition recognized by the traveling condition recognition part 91 and the current position of the vehicle V2 recognized by the GPS 92. Means configured to recognize the route to the destination includes a method for referring to data stored inside the navigation device N in advance, and a method for acquiring the data from a server and the like that are provided outside the vehicle V2 and can be communicated with the navigation device N.

The condition recognition part 94 acquires and recognizes the condition on the route recognized by the route recognition part 93 from a server S that is provided outside the vehicle V2 and can be communicated with the navigation device N. The condition on the route is preferably recognized at all points on the routed, but only a condition of a predefined and predetermined point (for example, the stop position designated by the passenger P) may be recognized.

The output part 95 is an output apparatus configured by a display that can visually present information, a loudspeaker and the like that can aurally present information, and a combination thereof. The information such as a recommended route and a condition on the route is presented to the passenger P via the output part 95.

The navigation device according to the present invention is not limited to a type mounted to the vehicle. For example, a device that is a mobile information terminal independent from the vehicle and has a navigation function may be used.

The information of the inside of the compartment C detected by the sensors mounted to the vehicle V2 is transmitted to the control part ECU. The route and the condition on the route recognized by the navigation device N are not only presented to the passenger P, but also transmitted to the control part ECU.

The control part ECU is constituted by one or more electronic circuit units including a CPU, a RAM, a ROM, an interface circuit and the like.

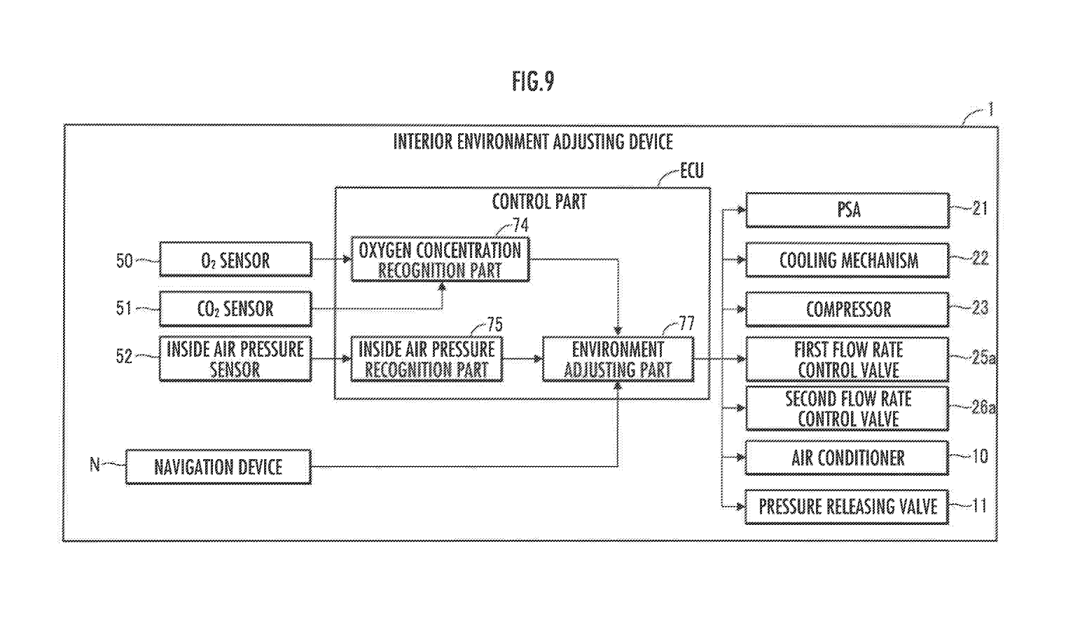

As shown in FIG. 9, the control part ECU comprises an oxygen concentration recognition part 74, an inside air pressure recognition part 75, and an environment adjusting part 77, as functions realized by a mounted hardware configuration or program. Processing by each of the function parts is sequentially executed.

The oxygen concentration recognition part 74 recognizes the oxygen concentration inside the compartment C based on the signals from the O₂ sensor 50 and the CO₂ sensor 51.

The inside air pressure recognition part 75 recognizes the inside air pressure that is air pressure inside the compartment C based on the signals from the inside air pressure sensor 52.

The environment adjusting part 77 defines a plan for adjusting the oxygen concentration inside the compartment C and the inside air pressure that is air pressure inside the compartment C during moving on the route, based on the condition that gives influences to at least one of the condition of the passenger P and the environment inside the compartment C at a passage predicted time point of the vehicle V2, in a region including a route recognized by the navigation device N or at least one part of the route.

Also, the environment adjusting part 77 adjusts the supply amount of gas to inside of the compartment C (i.e., at least one of the oxygen concentration and the inside air pressure that is air pressure inside the compartment C), and the supply amount of the oxygen-enriched air to the engine ENG, based on the adjusting plan, and the environment inside the compartment C recognized by the oxygen concentration recognition part 74 and the inside air pressure recognition part 75.

Concretely, the environment adjusting part 77 adjusts a generation amount of oxygen-enriched air by the oxygen enrichment mechanism 21, temperature of the oxygen-enriched air by the cooling mechanism 22, a degree of pressurizing the oxygen-enriched air and the outside air by the compressor 23, the supply amount of the oxygen-enriched air inside the compartment C by the first flow rate control valve 25a and the air conditioner blowing port 10, the supply amount of the oxygen-enriched air to the engine ENG by the second flow rate control valve 26a, and the exhaust amount of the air from inside of the compartment C by the pressure releasing valve 11, based on the adjusting plan.

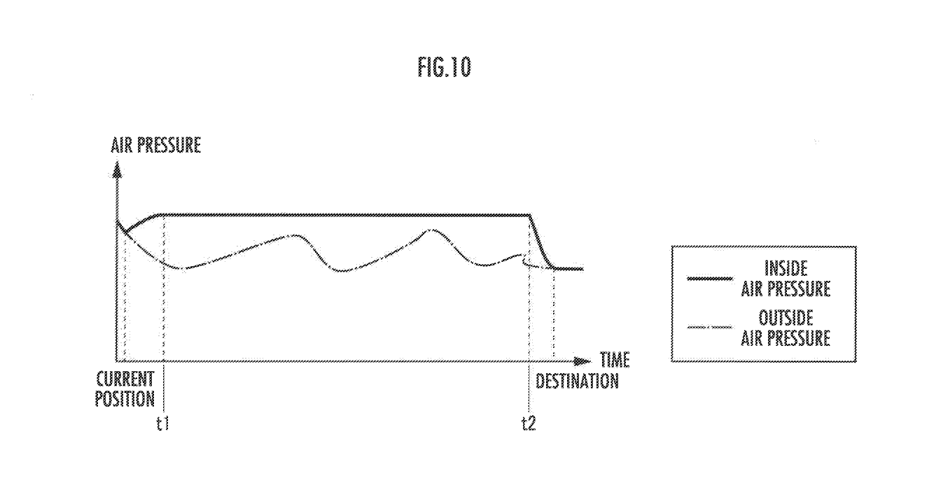

Here, with reference to FIG. 10, a concrete example of the adjusting plan ill be explained. In defining the adjusting plan, the environment adjusting part 77 first recognizes a road condition on the recognized route, a driving distance that is a distance of a predetermined zone (for example, between stop positions), a driving time required for moving in the predetermine zone, and air pressure at plural points on the route (a value shown by a dotted line in FIG. 10).

Here, “a stop position” includes a current position. Also, “air pressure” at plural points on the route includes a directly measured value, and a value estimated with reference to altitude, climate and the like at the point.

Then, for example, in a zone estimated that fatigue given to the passenger by the road condition is large (for example, a jammed zone, a zone of a long driving distance) in which the driving time exceeds 30 minutes (in FIG. 10, a zone from a time t1 to a time t2), the environment adjusting part 77 defines an adjusting plan that the oxygen-enriched air is more preferentially supplied to the inside of the compartment C than to the engine ENG, so that the oxygen concentration inside the compartment C is higher than atmospheric air, and the inside air pressure that is air pressure inside the compartment C is positive pressure to the outside air pressure that is air pressure around the vehicle V2.

This is because the road condition, the driving time, and the driving distance give significant influences to a fatigue feeling given to the passenger during driving. When an effect for maintaining and improving a physical condition is obtained by taking air with the higher oxygen concentration into a body, if a predetermined time (for example, 30 minutes) is exceeded, its effect is significantly increased.

The inside air pressure is defined so that it is positive pressure to any of air pressures at plural points on the recognized route, and is constant air pressure (target air pressure) (i.e., a value shown by a solid line in FIG. 10). By realizing constant positive pressure, regardless of a route, such environment that can efficiently maintain and improve the physical condition of the passenger by stabilizing the environment inside the compartment C is provided.

The inside air pressure is not immediately increased, but is increased step by step, so as to gradually approach target air pressure from when the adjustment is started (i.e., a current position).

This is because there is a risk that noise in ears is caused to the passenger and an uncomfortable feeling is given if the inside air pressure is rapidly increased. When the target air pressure is not so different from the current inside air pressure, the inside air pressure may be immediately adjusted to the target air pressure.

Also, the inside air pressure is not decreased to the outside air pressure when it reaches the stop position, but is decreased step by step, so as to gradually approach the outside air pressure as it approaches the stop position from a predetermined time (for example, a time at a predetermined distance from the stop position).

This is because there is a risk that an uncomfortable feeling is Oven to the passenger if the inside air pressure is rapidly decreased. Also, the air pressure difference between the outside air pressure and the inside air pressure becomes small. So, when it reaches the stop position and the door or the window is opened, the uncomfortable feeling to the passenger P due to the air pressure difference can be restrained, and the rapid opening of the door due to the air pressure difference can be restrained. When the outside air pressure is not so different from the current inside air pressure, the inside air pressure may be immediately adjusted to the outside air pressure.

Also, it may be configured so that the door is locked for a predetermined time and the inside air pressure is decreased during locking, after the vehicle V2 reaches the stop position.

Also, the vehicle V2 detects the condition of the engine ENG (rotation number, temperature) by sensors (not shown), and the environment adjusting part 77 recognizes the traveling condition of the vehicle V2 based on detection results. The environment adjusting part 77 supplies the oxygen-enriched air required for adjusting the environment inside the compartment C to the inside of the compartment C, and then supplies the excessive oxygen-enriched air to the engine ENG, when it is preferable that the oxygen-enriched air is supplied to the engine ENG (for example, when the temperature of the engine ENG is lower than predetermined temperature).

The adjusting plan according to the present invention is not limited to the above-mentioned plan. For example, such an adjusting plan for varying the inside air pressure according to the variation of the outside air pressure within a predetermined range (for example, the air pressure is 1.1 atm or more and 2 atm or less) may be adopted.

In the vehicle V2, the interior environment adjusting device 1 is configured by the above-mentioned sensors, navigation device N, the control part ECU (also, its respective function parts), the oxygen enrichment mechanism 21, the cooling mechanism 22, the compressor 23, the first flow rate control valve 25a, the second flow rate control valve 26a, the air conditioner blowing port 10, and the pressure releasing valve 11.

In the vehicle V2, processing for determining the adjusting plan and adjusting the environment inside the compartment C based on it is executed from when the passenger P inputs the desired traveling condition to the navigation device N, by the interior environment adjusting device 1.

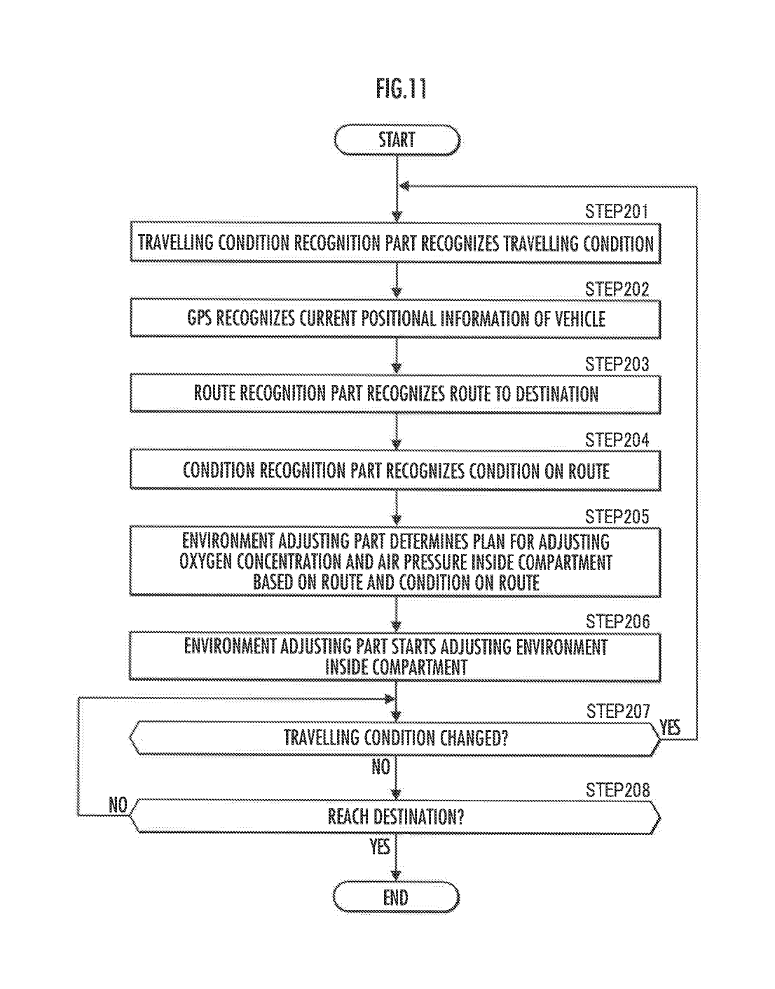

Then, with reference to FIG. 8, FIG. 9, and FIG. 11, processing executed for adjusting the environment inside the compartment C by each function part of the navigation device N and the control part ECU of the interior environment adjusting device 1 (interior environment adjusting method) will be explained. FIG. 11 is a flowchart indicating the processing executed by the navigation device N and the control part ECU.

In this processing, the traveling condition recognition part 91 of the navigation device N first recognizes the traveling condition desired by the passengers P based on the information input via the input part 90 of the navigation device N (FIG. 11/STEP 201).

Then, the GPS 92 of the navigation device N recognizes the current positional information of the vehicle V2 (FIG. 11/STEP 202).

The route recognition part 93 of the navigation device N recognizes the route to the destination based on the traveling condition recognized by the traveling condition recognition part 91, and the current position of the vehicle V2 recognized by the GPS 92 (FIG. 11/STEP 203).

The condition recognition part 94 of the navigation device N recognizes the condition on the route recognized by the route recognition part 93 (FIG. 11/STEP 204).

The environment adjusting part 77 of the control part ECU defines the plan for adjusting the oxygen concentration inside the compartment C and the inside air pressure that is air pressure inside the compartment C during moving on the route, based on the route recognized by the route recognition part 93 and the condition on the route recognized by the route recognition part 93 (FIG. 11/STEP 205).

The environment adjusting part 77 starts adjusting the environment inside the compartment C, based on the adjusting plan, and the environment inside the compartment C recognized by the oxygen concentration recognition part 74 and the inside air pressure recognition part 75 (FIG. 11/STEP 206).

Concretely, the environment adjusting part 77 starts adjusting the supply amount of gas to inside of the compartment C (i.e., at least one of the oxygen concentration and the inside air pressure that is air pressure inside the compartment C), and the supply amount of the oxygen-enriched air to the engine ENG.

Then, the traveling condition recognition part 91 of the navigation device N determines whether or not the traveling condition is change by the passenger P (FIG. 11/STEP 207).

When it is determined that the traveling condition is changed (YES in STEP 207), it is returned to STEP 201, and the navigation device N and the control part ECU defines an adjusting plan again, and starts adjusting the environment inside the compartment C based on a new adjusting plan.

When it is determined that the traveling condition is not changed (NO in STEP 207), the environment adjusting part 77 of the control part ECU determines whether or not the vehicle V2 reaches the destination, based on the signals from the navigation device N (FIG. 11, STEP 208).

When it is determined that the vehicle V2 does not reach the destination (NO in STEP 208), it is returned to STEP 207, and the traveling condition recognition part 91 of the navigation device N determines whether or not the traveling condition is changed by the passenger P.

When it is determined that the vehicle V2 reaches the destination (YES in STEP 208), the navigation device N and the control part ECU complete the current processing.

As explained above, the oxygen enrichment mechanism 21 is mounted to the vehicle V2, and the environment inside the compartment C is adjusted and the intake amount of the engine ENG is adjusted (thereby, the fuel consumption is improved, and the exhausted NOx, CO₂, HC and the like are reduced) by the generated oxygen-enriched air.

Thereby, as is similar to a conventional vehicle to which the oxygen enrichment mechanism is mounted, in addition to additional values for improving fuel consumption and reducing the exhausted NOx, CO₂, HC and the like, a new additional value as physical condition maintaining and improving means is provided in the vehicle V2. The new additional value is provided in a form that can be easily felt by the passenger P.

Additionally, in the vehicle V2, the environment inside the compartment C is adjusted based on the adjusting plan defined with reference to the condition on the route to the destination, not based on the condition of the current position of the vehicle V2. That is to say, in the vehicle V2, the environment inside the compartment C is adjusted based on a zone that is a route to the destination, not based on one point that is a current position of the vehicle V2.

Thereby, the vehicle V2 to which the interior environment adjusting device 1 is mounted can restrain frequent variation of the inside air pressure that is air pressure inside the compartment C, and maintain and improve the physical condition due to oxygen supply at a proper timing, regardless of the route. Also, such environment for efficiently restraining fatigue and maintaining and improving the physical condition can be provided to the passenger P of the vehicle V2.

### Other Embodiments

The illustrated embodiments have been explained above, however, the present invention is not limited to these embodiments.

For example, in the above-mentioned embodiments, the environment inside the compartment C is adjusted by adjusting the oxygen concentration and the inside air pressure that is air pressure inside the compartment C. However, the present invention is not limited to such a configuration, and the inside environment may be adjusted by adjusting only either one of the oxygen concentration and the inside air pressure.

For example, in the above-mentioned embodiments, the environment adjusting part 77 executes adjustment, so that the oxygen concentration is improved and the inside air pressure that is air pressure inside the compartment C is positive pressure to the outside air pressure that is air pressure around the vehicle V1. Also, the oxygen-enriched air is supplied to the engine that is an internal combustion engine, as well as the inside of the compartment C.

However, the interior environment adjusting device according to the present invention is not limited to such a configuration, and may be any device that executes at least one of the adjustment such that the inside air pressure that is inside air pressure of the mobile body is positive pressure to the outside air pressure that is air pressure around the mobile body, and the adjustment such that the inside oxygen concentration of the mobile body is made higher than atmospheric air.

In the above-mentioned embodiments, the environment inside the compartment C is adjusted and the oxygen-enriched air is supplied to the engine ENG, using the passenger P as a reference. Here, the passenger P includes a fellow passenger other than a driver.

The passenger that is a reference according to the present invention may be anyone present inside while the mobile body is moving, such as either one or both of the driver and the fellow passenger.

In the above-mentioned embodiments, the environment inside the compartment C is adjusted by adjusting the supply amount of the oxygen-enriched air to the inside of the compartment C, and adjusting the opening degree of the pressure releasing valve 11 that is an exhaust amount adjusting mechanism.

However, the interior environment adjusting device according to the present invention is not limited to such a configuration, and various known methods may be used as an environment adjusting method. For example, a method for supplying oxygen itself by mounting an oxygen tank to the mobile body, not supplying the oxygen-enriched air, may be used, and a method for directly removing nitrogen from the inside air by providing a nitrogen removing device inside may be used as an oxygen concentration adjusting method. Also, a method for varying an inside capacity or temperature of the mobile body may be used as a method for adjusting the inside air pressure that is inside air pressure.

In the above-mentioned embodiments, in determining the requirements and contents for adjusting the environment inside the compartment C, the presence and number of the passengers, the physical condition, the opening condition of the door and the window, and the traveling condition are sequentially recognized.

However, the interior environment adjusting device according to the present invention is not limited to such a configuration, and may be any device that executes the adjustment, so that the inside air pressure that is inside air pressure of the mobile body is positive pressure to the outside air pressure that is air pressure around the mobile body, the inside oxygen concentration of the mobile body is higher than atmospheric air, or both of them are satisfied. For example, the presence and number of the passengers, the physical condition, the opening condition of the door and the window, and the traveling condition may be recognized in the different order than that in the embodiments, and at least any one or all of them may be omitted.

In the above-mentioned second embodiment, the processing for determining the adjusting plan and adjusting the environment inside the compartment C based on it is executed from when the desired traveling condition is input to the navigation device N by the passenger P. However, the present invention is not limited to such a configuration, and timing for determining the adjusting plan and adjusting the inside environment based on it may be set appropriately.

For example, only when the physical condition of the passenger P is recognized and it is determined as a predetermined physical condition (for example, a physical condition determined that there is a need of improving and enhancing the physical condition), the inside environment may be adjusted based on a predefined adjusting plan.

Also, in the above-mentioned embodiments, the oxygen-enriched air generated by the oxygen enrichment mechanism 21 is supplied to the inside of the compartment C, and is also supplied to the engine ENG. However, the present invention is not limited to such a configuration.

For example, in the above-mentioned embodiments, after the environment inside the compartment C is adjusted, the excessive oxygen-enriched air is supplied to the engine ENG, but the inside environment may be adjusted using the excessive oxygen-enriched air by preferentially supplying the oxygen-enriched air to the internal combustion engine. Also, for example, the oxygen-enriched air may be used only for adjusting the inside environment, and may not be supplied to the internal combustion engine.

In the above-mentioned embodiments, a vehicle having an engine as an internal combustion engine is explained. However, the mobile body according to the present invention is not limited to such a vehicle. For example, the present invention may be applied to an electric automobile having a motor instead of an internal combustion engine.

### REFERENCE SIGNS LIST

1 interior environment adjusting device
11 pressure releasing valve (exhaust amount adjusting mechanism)
10 air conditioner blowing port
20 air introduction hole
21 oxygen enrichment mechanism
22 cooling mechanism
23 compressor (outside air pressurizing mechanism, oxygen-enriched air pressurizing mechanism)
24 tank
25 inside supply path
25a first flow rate control valve
26 intake supply path
26a second flow rate control valve
27 bypass passage
30 ENG rotation number sensor
31 ENG temperature sensor
32 AP opening degree sensor
40 camera
41 brain wave sensor
42 pulse sensor
43 breath sensor
50 O₂ sensor
51 CO₂ sensor
52 inside air pressure sensor
53 door sensor
60 outside air pressure sensor
70 passenger recognition part
71 physical condition recognition part
72 opening condition recognition part
73 traveling condition recognition part
74 oxygen concentration recognition part
75 inside air pressure recognition part
76 outside air pressure recognition part
77 environment adjusting part
80 mobile information terminal
90 input part
91 traveling condition recognition part

### 92 GPS

93 route recognition part
94 condition recognition part
95 output part
C compartment
ENG engine (internal combustion engine)
ECU control part
N navigation device
P passenger
S server
S1 condition storing part
V1, V2 vehicle (mobile body)

What is claimed is:

1. An interior environment adjusting device for adjusting an inside environment of a mobile body, comprising:
an environment adjusting part for executing at least one of adjustment to make inside air pressure that is air pressure in the inside into positive pressure with respect to outside air pressure that is air pressure around the mobile body, and adjustment to make an oxygen concentration in the inside to a higher concentration than in the outside air.

2. The interior environment adjusting device according to claim 1,
wherein the environment adjusting part executes adjustment to make the inside air pressure into the positive pressure with respect to the outside air pressure and also to make differential pressure between the outside air pressure and the inside air pressure constant.

3. The interior environment adjusting device according to claim 1, comprising:
a passenger recognition part for recognizing presence of a passenger in the inside,
wherein the environment adjusting part executes the adjustment when the passenger is present in the inside.

4. The interior environment adjusting device according to claim 3,
wherein the passenger recognition part recognizes number of passengers, and
the environment adjusting part executes the adjustment to make the oxygen concentration in the inside to the higher concentration than in the outside air by adjusting an inside oxygen supply amount based on the recognized number of the passengers.

5. The interior environment adjusting device according to claim 1, comprising:
a physical condition recognition part for recognizing a physical condition of a passenger,
wherein the environment adjusting part executes the adjustment when the physical condition of the recognized passenger is a predetermined physical condition.

6. The interior environment adjusting device according to claim 5,
wherein the physical condition recognition part recognizes the physical condition of the passenger based on biological information of the passenger transmitted from a mobile information terminal.

7. The interior environment adjusting device according to claim 1,
wherein the environment adjusting part executes the adjustment step by step so that the inside air pressure is positive pressure with respect to the outside air pressure.

8. The interior environment adjusting device according to claim 1, comprising:
an exhaust amount adjusting mechanism for adjusting an exhaust amount of air from the inside; and
a traveling condition recognition part for recognizing a traveling condition of the mobile body,
wherein the exhaust amount adjusting mechanism increases the exhaust amount when it is recognized that the mobile body is under a stop condition.

9. The interior environment adjusting device according to claim 1, comprising:
a flow rate control valve for adjusting a supply amount of air into the inside,
wherein the environment adjusting part is configured to adjust the supply amount of the air into the inside by adjusting an opening degree of a flow rate control valve, and execute the adjustment to make the inside air pressure into positive pressure with respect to the outside air pressure.

10. The interior environment adjusting device according to claim 9, comprising:
an outside air pressurizing mechanism for pressurizing outside air introduced from outside of the mobile body,
wherein the environment adjusting part adjusts the supply amount of the pressurized outside air into the inside by adjusting the opening degree of the flow rate control valve, and executes the adjustment to make the inside air pressure into positive pressure to the outside air pressure.

11. The interior environment adjusting device according to claim 1, comprising:
an oxygen enrichment mechanism for generating oxygen-enriched air; and
a flow rate control valve for adjusting a supply amount of the oxygen-enriched air in the inside from the oxygen enrichment mechanism,
wherein the environment adjusting part is configured to adjust the supply amount of the oxygen-enriched air into the inside by adjusting an opening degree of a flow rate control valve, and execute the adjustment to make the oxygen concentration in the inside to the higher concentration than in the outside air.

12. The interior environment adjusting device according to claim 11, comprising:
an outside air pressurizing mechanism for pressurizing outside air introduced from outside of the mobile body,
wherein the oxygen enrichment mechanism generates oxygen-enriched air using the pressurized outside air.

13. A vehicle comprising:
the interior environment adjusting device according to claim 1; and
an internal combustion engine,
wherein the interior environment adjusting device has an oxygen enrichment mechanism for generating oxygen-enriched air, and
the environment adjusting part supplies the generated oxygen-enriched air to the inside and the internal combustion engine.

14. An interior environment adjusting device for adjusting inside environment of a mobile body, comprising:
a navigation device; and
an environment adjusting part for adjusting at least one of inside oxygen concentration and inside air pressure that is air pressure in the inside,
wherein the navigation device has a route recognition part for recognizing a route from a first point to a second point, and
a condition recognition part for recognizing a condition that gives influences to at least one of a condition of a passenger of the mobile body and the inside environment in a region including the recognized route or at least one part of the route, and
the environment adjusting part defines an adjusting plan of at least one of the oxygen concentration and the inside air pressure while moving through the route based on the recognized route and the condition at a passage predicted time point of the mobile body, and adjusts at least one of the oxygen concentration and the inside air pressure based on the adjusting plan.

15. The interior environment adjusting device according to claim 14,
wherein the condition recognition part recognizes a road condition on the recognized route, and
the environment adjusting part defines the adjusting plan based on the road condition.

14. interior environment adjusting device according to claim 14,
wherein the condition recognition part recognizes a driving distance that is a distance of a predetermined zone on the recognized route, and
the environment adjusting part defines the adjusting plan based on the driving distance.

17. The interior environment adjusting device according to claim 14,
wherein the condition recognition part recognizes a driving time required for moving in a predetermined zone on the recognized route, and
the environment adjusting part defines the adjusting plan to adjust at least one of the oxygen concentration and the inside air pressure only in the zone in which the driving time becomes not less than a predetermined time.

18. The interior environment adjusting device according to claim 14,
wherein the condition recognition part recognizes the air pressure at a stop position on the recognized route, and
the environment adjusting part defines the adjusting plan so that the inside air pressure approaches the air pressure at the stop position as the mobile body approaches the stop position or when the mobile body reaches the stop position.

19. The interior environment adjusting device according to claim 14,
wherein the condition recognition part recognizes air pressure at plural points on the recognized routes, and
the environment adjusting part defines the adjusting plan so that the inside air pressure becomes a positive pressure with respect to any of the recognized air pressure at the plural points, and becomes constant.

20. An interior environment adjusting method for adjusting inside environment of a mobile body, comprising:
a step in which a route recognition part recognizes a route from a first point to a second point;
a step in which a condition recognition part recognizes a condition giving influences to at least one of a passenger condition of the mobile body and the inside environment in a region including the recognized route or at least one part of the route;
a step in which an environment adjusting part defines an adjusting plan of at least one of an oxygen concentration inside the mobile body while moving on the route and inside air pressure that is air pressure inside the mobile body based on the recognized route and the condition at a passage predicted time point of the mobile body; and
a step in which the environment adjusting part adjusts at least one of the oxygen concentration and the inside air pressure based on the adjusting plan.
